(19) United States
(12) Patent Application Publication
(10) Pub. No.: US 2008/0153982 A1
(43) Pub. Date: Jun. 26, 2008

(54) Vinyl-Thiocarbonate and Polyol Containing Block Copolymers

(76) Inventors: John Ta-Yuan Lai, Broadview Heights, OH (US); William F. Masler, Medina, OH (US)

Correspondence Address: LEGAL DEPARTMENT;LUBRIZOL ADVANCED MATERIALS, INC, 9911 BRECKSVILLE ROAD, CLEVELAND, OH, 44141-3247, US

(21) Appl. No.: 11/960,876

(22) Filed: Dec. 20, 2007

Related U.S. Application Data
(60) Provisional application No. 60/870,853, filed on Dec. 20, 2006.

(51) Int. Cl. C08L 53/02; C08L 53/00

(52) U.S. Cl. 525/91; 525/90

(57) ABSTRACT

Block copolymers comprising polyols and/or siloxanes and vinyl-thiocarbonate blocks can be made by reacting a thiocarbonate compound such as a dithio- or trithiocarbonate with generally any hydroxyl-terminated polysiloxane via an esterification reaction. The polysiloxane can have a very wide number average molecular weight range and can be chain extended and/or crosslinked as by using a polyisocyanate or a polycarboxylic acid. Desirably, vinyl compounds are then reacted in situ into the thiocarbonate to increase molecular weight thereof. The block copolymers can be used in personal care applications.

### CROSS-REFERENCE TO RELATED APPLICATION

This application claims priority to U.S. provisional application Ser. No. 60/870,853, filed on Dec. 20, 2006.

### FIELD OF THE INVENTION

The present invention relates to polymeric block copolymers of thiocarbonates and hydroxyl containing compounds (polyols) wherein the thiocarbonate can contain large repeat units derived from vinyl monomers such as conjugated dienes, styrenic monomers, or (meth)acrylic monomers.

### BACKGROUND OF THE INVENTION

Heretofore, various block copolymers have been made containing polyols residues. For example, Kim Huan, et al, Synthesis and Properties of Polydimethylsiloxane-Containing Block Copolymers via Living Radical Polymerization, Journal of Polymer Science: Part A: Polymer Chemistry, Vol. 39 pp 1833-1842 (2001) John Wiley & Sons Inc., relates to polydimethylsiloxane (PDMS) block copolymers synthesized by using PDMS macroinitators with copper-mediated living radical polymerization. Diamino PDMS led to initiators that gave ABA block copolymers, but there was low initiator efficiency and molecular weights are somewhat uncontrolled. The use of mono- and difunctional carbinol-hydroxyl functional initiators led to AB and ABA block copolymers with narrow polydispersity indices (PDIs) and controlled number-average molecular weights (Mₙ). Polymerization with methyl methacrylate (MMA) and 2-dimethyl-aminoethyl methacrylate (DMAEMA) was discovered with a range of molecular weights produced. Polymerizations proceeded with first-order kinetics indicative of 28 and 84 wt. % poly(methyl methacrylate) with Mₙ of between 7.6 and 35 K (PDI<1.30), which show thermal transitions characteristic of block copolymers. ABA block copolymers with DMAEMA led to amphiphilic block copolymers with Mₙ's between 9.5 and 45.7 K (PDIs of 1.25-1.70), which formed aggregates in solution with a critical micelle concentration of 0.1 g dm⁻³ as determined by pyrene fluorimetry experiments. Mono-carbinol functional PDMS gave AB block copolymers with both MMA and DMAEMA.

U.S. Publication 2002098214 relates to a process for making a polysiloxane block copolymer which is built up from units of the formula [A] [B], in which A is a polymeric block built up from a radically polymerizable monomer, and B is a polysiloxane block, the process comprising the steps of forming a polysiloxane macroinitiator by grafting a radical initiator onto a polysiloxane via a nucleophilic displacement reaction between groups on the polysiloxane and radical initiator respectively, and reacting the polysiloxane macroinitiator so obtained with radically polymerizable monomers in an atom transfer radical polymerization reaction to form a polysiloxane block copolymer. Also provided are cosmetic and personal care compositions, such as hair styling compositions, containing the polysiloxane block copolymers.

WO 0107496 relates to novel block polymers of ethylenically unsaturated monomers and ethylenically unsaturated carboxylates such as vinyl acetate that are made by transition metal mediated, atom transfer polymerization of an ethylenically unsaturated monomer with an alpha, omega di-functional polymer precursor having repeating units derived from an ethylenically unsaturated carboxylate, such as vinyl acetate. Also, novel alpha, omega di-functional polymer precursors may be made by the steps of (a) reacting an ethylenically unsaturated carboxylate with a radical initiator having a substitutable functional group; and (b) substituting the functional groups on the product of step (a) with substituents active for the formation of block polymers in a transition metal mediated, atom transfer polymerization process.

U.S. Pat. No. 6,685,925 relates to a cosmetic or personal care compositions, such as for styling hair, comprise a thermoplastic elastomer which is a block copolymer comprising a core polymer having a backbone comprising at least a proportion of C—C bonds and two or more flanking polymers. Each flanking polymer is covalently bound to an end of the core polymer and the copolymer is soluble at a level of at least 1% by weight in water at 25° C. The compositions comprise a cosmetically acceptable diluent or carrier.

### SUMMARY OF THE INVENTION

Block copolymers are provided by polymerizing free radically addition polymerizable ethylenically unsaturated monomers in the presence of a macroinitiating RAFT ester adduct.

In one aspect of the invention, the RAFT ester adduct is synthesized by the esterification reaction of a hydroxyl containing compound and a thiocarbonate RAFT reagent that contains one or two terminal carboxylic acid groups. Optionally, depending on the stoichiometry of the reactants employed in the formation of the RAFT ester adduct, chain extension of the RAFT ester adduct can be effected via reaction with a polyisocyanate or a dicarboxylic acid compound to impart elastomeric and/or adhesive properties. Free radically addition polymerizable ethylenically unsaturated monomers are subsequently polymerized in the presence of the RAFT ester adduct to form A-B-A, B-A-B, A-B, AₙB, AₙBₘ, or -(A-B)ₓ— block copolymers. The A block contains the residue of a hydroxy containing compound (monoalcohol or polyol) and the B block contains the residue of a thiocarbonate containing compound which includes optional repeating units polymerized from addition polymerizable ethylenically unsaturated monomers.

In another aspect of the invention, the free radically addition polymerizable ethylenically unsaturated monomer is selected from any free radically polymerizable vinyl containing compound or monomer such as, for example, an acrylic monomer to impart desirable properties such as film forming, water thickening, elastomeric, adhesion, and the like. The vinyl repeat units are optionally neutralized or partially neutralized with a base or an acid if they contain and acid or an amine group.

In an alternative aspect of the invention, the vinyl containing monomers can be polymerized in presence of the thiocarbonate RAFT reagent having one or two carboxylic end groups before the ester adduct is formed to obtain a carboxyl terminated polymer, which in turn is subsequently esterified with a hydroxyl containing compound.

### DETAILED DESCRIPTION OF THE INVENTION

### Thiocarbonate RAFT Reagents

In one aspect, the thiocarbonate RAFT reagents of the present invention that are reacted with hydroxyl containing compounds to form the ester adduct are polythiocarbonates such as dithiocarbonate or trithiocarbonate compounds and derivatives thereof. By the term “thiocarbonate” it is meant a compound having at least one segment of the formula:

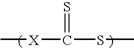

where “X” comprises OR, SR, or NR₂, with R representing various hydrocarbon, hetero atom, and/or hydrogen containing structures or the like as illustrated hereinbelow, but not limited thereto.

Suitable trithiocarbonate compounds useful as a reactant for forming the RAFT ester adduct of the present invention are disclosed in U.S. Pat. Nos. 6,596,899 and 6,894,116 to Lai and Lai et al., respectively, both hereby fully incorporated by reference including the preparation thereof. In one embodiment, the trithiocarbonate compounds are represented by the following general formula:

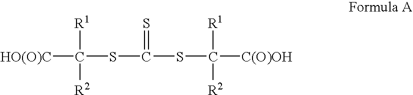

wherein R¹ and R², independently represent a linear and branched, substituted or unsubstituted C₁ to C₆ alkyl; substituted or unsubstituted C₆ to C₂₄ aryl, optionally containing heteroatoms selected from nitrogen, oxygen, sulfur, and phosphorous; R¹ and R² taken together with the carbon atom to which they are attached, independently, can form a cyclic ring having from 3 to about 12 total carbon atoms. When R¹ and R² are substituted, the substituents are independently selected from linear and branched C₁ to C₆ alkyl, C₁ to C₂₀ alkoxy, C₆ to C₁₄ aryl, halogen (e.g., chlorine, bromine, fluorine, and iodine), cyano, nitro, and combinations thereof. In one aspect of the invention, R¹ and R², independently, are selected from methyl and phenyl groups. Examples of trithiocarbonate compounds include s,s′-bis-2-methyl-2-propanoic acid-trithiocarbonate and s,s′-bis-(2-phenyl-2-propanoic acid)-trithiocarbonate.

The abbreviated reaction formula for one method for the preparation of the foregoing trithiocarbonate RAFT regents is generally written as follows:

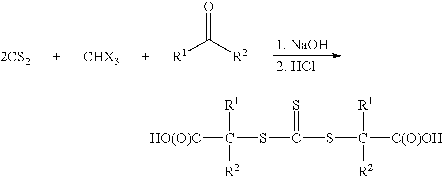

where X is a halogen atom and R1 and R2 are as previously defined.

The process utilized to form s,s′-bis-(α,α′-disubstituted-α″-acetic acid)-trithiocarbonate compounds is generally a multi-step process and includes combining the carbon disulfide and a base whereby an intermediate trithio structure is formed. Ketone can serve as solvent for the carbon disulfide/base reaction and thus can be added in the first step of the reaction. In the second step of the reaction, the haloform, or haloform and ketone, or a α-trihalomethyl-α-alkanol are added to the trithio intermediate mixture and reacted in the presence of additional base. The formed reaction product, is subsequently acidified, thus completing the reaction and forming the above described s,s′-bis-(α,α′-disubstituted-α″-acetic acid)-trithiocarbonate compound.

Another aspect of present invention utilizes trithiocarbonate compounds having the following formula:

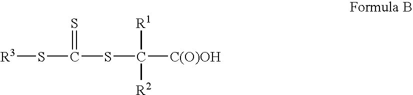

where R¹ and R² are as defined previously; and R³ is selected from substituted or unsubstituted benzyl and linear and branched, substituted or unsubstituted C₁ to C₁₈ alkyl. When R³ is substituted, the substituents are independently selected from C₁ to C₅ alkyl; C₁ to C₂₀ alkoxy; C₁ to C₁₈ hydroxyalkyl; C₆ to C₁₈ aryl; C₇ to C₂₄ aralkyl; C₁ to C₁₀ cyanoalkyl; C₁ to C₁₀ aminoalkyl; mono-(C₁ to C₄) alkylamino (C₁ to C₈) alkyl; di-(C₁ to C₄) alkylamino (C₁ to C₈) alkyl; C₁ to C₂₄ carboxylalkyl; C₁ to C₁₀ mercaptoalkyl; carboalkoxyalkyl (alkoxycarbonylalkyl), where the alkoxy moiety contains 1 to 10 carbon atoms and the alkyl moiety contains 1 to 20 carbon atoms; halogen (e.g., chlorine, bromine, fluorine, and iodine); hydroxyl and combinations thereof.

Dithiocarbonate compounds which are utilized in some embodiments of the present invention are disclosed in U.S. application Ser. No. 10/278,335 filed Oct. 23, 2002 and U.S. application Ser. No. 10/681,679 filed Oct. 8, 2003, herein fully incorporated by reference including the preparation thereof. In one aspect the dithiocarbonate compound is a dithiocarbamate represented by the following formula:

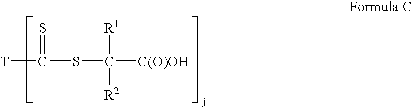

where j is 1 or 2, with the proviso that when j is 1, T is —NR⁵R⁶; and when j is 2, T is a divalent radical having a nitrogen atom directly connected to each carbon atom of the two thiocarbonyl groups present; R¹ and R² are as previously defined.

In Formula C, when J is 1 and T represents the radical —NR⁵R⁶ wherein R⁵ and R⁶ independently represent hydrogen; a linear and branched, substituted or unsubstituted C₁ to C₁₈ alkyl; substituted or unsubstituted C₆ to C₂₄ aryl, optionally containing heteroatoms, such as but not limited to nitrogen, oxygen, sulfur, and phosphorous; substituted or unsubstituted C₇ to C₁₈ arylalkyl; substituted or unsubstituted C₂ to C₁₈ alkenyl; or a residue of a polyalkylene glycol ether having from 4 to about 200 carbon atoms. When R⁵ and R⁶ are substituted, the substituents are independently selected from linear and branched C₁ to C₆ alkyl, C₁ to C₂₀ alkoxy, C₆ to C₁₄ aryl, halogen (e.g., chlorine, bromine, fluorine, and iodine), cyano, nitro, and combinations thereof. Illustrative examples of poly(oxyalkylene) glycol ethers are poly(ethylene oxide) ethers, poly(propylene oxide) ethers, and poly(ethylene oxide/propylene oxide) ethers.

Radicals R⁵ and R⁶ can also be derived from amines such as, but not limited to, piperazine, morpholine, pyrrolidine, piperidine, 4-alkyl amino-2,2,6,6-tetramethyl piperidine, 1-alkylamioalkyl-3,3,5,5-tetramethyl-2-piperazinone, hexamethyleneimine, phenothiazine, iminodibenzyl, phenoxazine, N,N′-diphenyl-1,4-phenylenediamine, dicyclohexylamine and derivatives thereof. R⁵ and R⁶ taken together with the nitrogen atom to which they are attached can form a substituted or unsubstituted monocyclic or multicyclic ring system, optionally containing heteroatoms (in addition to the nitrogen atom attached to the thiocarbonyl moiety), having a total of from 4 to about 12 carbon atoms. Exemplary heteroatoms include but are not limited to nitrogen, oxygen, sulfur and phosphorous. Exemplary heteroatom containing moieties are benzotriazole, tolyltriazole, imidazole, 2-oxazolidone, 4,4-dimethyloxazolidone and the like. The R⁵ and R⁶ substituents, independently, can be the same as described herein with respect to R¹³ as set forth herein below. R⁵ and R⁶ are, independently, a phenyl group or an alkyl or substituted alkyl having from 1 to about 18 carbon atoms such as a methyl group, or R⁵ and R⁶, independently, are hexamethylene.

In Formula C, when J is 1, the dithiorcarbamate compound is a S-(α,α′-disubstituted-α″-acetic acid) of the formula:

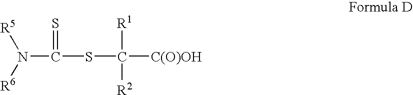

wherein R¹, R², R^{5′}, and R⁶ are as defined above.

In Formula C, when j is 2, the dithiocarbarbamate compound is a bis-S-(α,α′-disubstituted-α″-acetic acid) dithiocarbamate represented by the following formula:

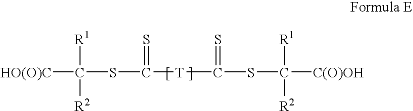

wherein R¹ and R² are defined hereinabove; and T is a divalent bridging radical having a nitrogen atom directly connected to each of the flanking thiocarbonyl groups present. In one aspect of the invention, T is represented by the following divalent bridging radicals:

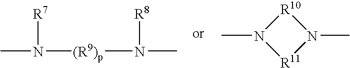

wherein p is 0 or 1; R⁷ and R⁸, independently represents hydrogen; linear and branched, substituted or unsubstituted C₁ to C₁₈ alkyl; substituted or unsubstituted C₆ to C₂₄ aryl; substituted or unsubstituted C₇ to C₁₈ arylalkyl; substituted or unsubstituted C₂ to C₁₈ alkenyl; R⁹ is a bridging moiety, selected from substituted and unsubstituted C₂ to C₁₈ alkylene, a divalent polyalkylene glycol ether residue having from 4 to about 200 carbon atoms; a carbonyl group, a heteroatom selected from nitrogen, oxygen, sulfur and phosphorous; and combinations of thereof. When R⁷, R⁸, and R⁹ are substituted, the substituents are independently selected from linear and branched C₁ to C₆ alkyl, C₁ to C₂₀ alkoxy, C₆ to C₁₄ aryl, halogen (e.g., chlorine, bromine, fluorine, and iodine), cyano, nitro, and combinations thereof. R¹⁰ and R¹¹ independently represent substituted or unsubstituted C₁ to C₄ alkylene group. In one aspect of the invention the sum of the carbon atoms represented by R¹⁰ and R¹¹ range from 3 to 5.

In another aspect of the invention the divalent radical T of Formulae C and E is selected from the formulae below:

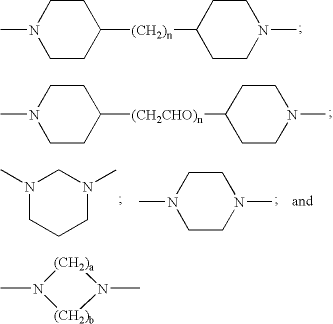

wherein in the above formulae n is 0 to 18 in one aspect of the invention and 1 to 6 in another aspect; and a and b independently represent an integer from 1 to 3 in one aspect and the sum of a+b ranges from 3 to 5 in another aspect of the invention.

The S-(α,α′-disubstituted-α″-acetic acid) or bis S-(α,α′-disubstituted-α″-acetic acid) dithiocarbamates are generally a reaction product of a metal salt of a dithiocarbamate (can be generated in situ from amine, carbon disulfide and metal hydroxide), a haloform, and a ketone. A phase transfer catalyst, solvent, and a base such as sodium hydroxide or potassium hydroxide can also be utilized to form the S-(α,α′-disubstituted-α″-acetic acid) or bis S-(α,α′-disubstituted-α″-acetic acid) dithiocarbamates.

It is to be understood throughout the application formulas, reaction schemes, mechanisms, etc., and the specification that metals such as sodium or bases such as sodium hydroxide are referred to and the application of the present invention is not meant to be solely limited thereto. Other metals or bases such as, but not limited to, potassium and potassium hydroxide, respectively, are contemplated by the disclosure of the present invention.

In another aspect of the invention the dithiocarbonate compound is selected from an alkoxy dithiocarbonate (xanthate) of the following general formula: 3475-01

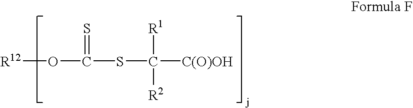

wherein j is 1 to 4 in one aspect and 1 or 2 in another aspect; R¹ and R² are as previously defined; and R¹² is selected from a linear and branched, substituted or unsubstituted C₁ to C₁₂ alkyl; linear and branched, substituted or unsubstituted C₂ to C₁₂ alkenyl; substituted or unsubstituted C₆ to C₂₄ aryl, optionally containing heteroatoms, such as but not limited to nitrogen, oxygen, sulfur, and phosphorous; C₇ to C₁₈ arylalkyl; an acyl group; alkoxyalkyl having 1 to 20 carbon atoms; a residue of a polyalkylene glycol ether having from 4 to about 200 carbon atoms derived from a polyalkylene glycol monoaryl ether having from 3 to 200 carbon atoms; a polyfluoroalkyl group having 1 to 25 carbon atoms, such as, for example, trifluoromethyl and 2-trifluoroethyl; a phosphorous containing C₁ to C₁₀ alkyl. In one aspect of the invention, R¹² represents alkyl and alkenyl groups from 1 to 6 carbon atoms. When R¹² is substituted, the substituents are independently selected from C₁ to C₅ alkyl; C₂ to C₁₀ alkenyl; C₁ to C₂₀ alkoxy; C₁ to C₁₈ hydroxyalkyl; C₆ to C₁₈ aryl; C₇ to C₂₄ aralkyl; C₁ to C₁₀ cyanoalkyl; an amino group, such as for example, —NH₂, C₁ to C₁₀ aminoalkyl, mono-(C₁ to C₄) alkylamino (C₁ to C₈) alkyl, di-(C₁ to C₄) alkylamino (C₁ to C₈) alkyl; C₁ to C₂₄ carboxylalkyl; C₁ to C₁₀ mercaptoalkyl; carboalkoxyalkyl (alkoxycarbonylalkyl), where the alkoxy moiety contains 1 to 10 carbon atoms and the alkyl moiety contains 1 to 20 carbon atoms; carboalkoxy (alkoxycarbonyl) where the alkoxy moiety contains 1 to 10 carbon atoms; alkylcarbonyl where the alkyl moiety contains 1 to 20 carbon atoms; alkylarylcarbonyl where the alkyl group contains 1 to 20 carbon atoms and the aryl group contains 6 to 18 carbon atoms; alkoxycarbonyl where the alkoxy moiety contains 1 to 10 carbon atoms; arylcarbonyl group where the aryl group contains 6 to 18 carbon atoms; arylalkylcarbonyl where the aryl group contains 6 to 18 carbon atoms and the alkyl group contains 1 to 20 carbon atoms; a heterocyclic group containing 3 to 8 carbon atoms, wherein the hetero atom is selected from one or more of oxygen, nitrogen, sulfur, and combinations thereof; an acyloxy group; a carbamoyl group; a phthalimido group; a maleimido group; a succinimido group; amidino group; guanidimo group; a quaternary ammonium salt substituent; an allyl group; epoxy group; halogen (e.g., chlorine, bromine, fluorine, and iodine); carboxyl and alkali metal salts thereof; hydroxyl; cyano, nitro; and combinations thereof.

The compounds of the above formula are generally identified as O-alkyl-S-(α,α′-disubstituted-α″-acetic acid) xanthates. The O-alkyl-S-(α,α′-disubstituted-α″-acetic acid) xanthates are generated as the reaction product of an alkoxylate salt, carbon disulfide, a haloform, and a ketone. Alternatively, a metal salt of xanthate can be utilized in place of the alkoxylate salt and carbon disulfide.

The general reaction mechanism for forming the O-alkyl-S-(α,α′-disubstituted-α″-acetic acid) xanthates is as follows:

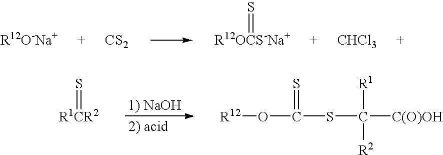

wherein R¹, R² and R¹² are as previously defined.

It is to be understood that while a few specific thiocarbonate compounds have been described herein, the present invention is not limited to such compounds.

The various thiocarbonate compounds including the various trithiocarbonates and the various dithiocarbonates are prepared in a manner as set forth in the above noted U.S. Pat. No. 6,596,899; U.S. Pat. No. 6,894,116; U.S. application Ser. No. 10/278,335 filed Oct. 23, 2002; and U.S. application Ser. No. 10/681,679 filed Oct. 8, 2003, all of which are hereby fully incorporated by reference with regard to reaction conditions including temperature, type and amount of catalysts, and the like.

### Hydroxyl Containing Compound

The hydroxyl containing compound that can be utilized in the synthesis of the RAFT ester adduct of the present invention can be selected from a monoalcohol or a polyol. In one aspect of the invention, suitable monoalcohols include primary and secondary monoalcohols. In another aspect of the invention, the hydroxyl group is located at a terminal end of the monoalcohol compound. The monoalcohols include but are not limited to branched and linear alcohols containing 4 to 100 carbon atoms. Exemplary monoalcohols include C₈ to C₅₀ fatty alcohols such as, for example, capryl alcohol, pelargonic alcohol, capric alcohol, lauryl alcohol, myristyl alcohol, cetyl alcohol, stearyl alcohol, isostearyl alcohol, arachidyl alcohol, behenyl alcohol, lignoceryl alcohol, ceryl alcohol, montanyl alcohol, myricyl alcohol, and geddyl alcohol; polyalkene monoalcohols such as, for example, polyethylene monoalcohol available from Baker Petrolite under the Unilin® trade name (e.g., product designation 425); alkoxypoly(oxyalkylene) glycols wherein the alkoxy group contains 1 to 10 carbon atoms and the oxyalkylene group contains 2 to 4 carbon atoms (e.g., methoxypolyethylene glycol (MPEG)). Exemplary alkoxypoly(oxyalkylene) glycols are represented by the formula:

RO—(R¹³O)ₘ—H

wherein R is a linear and branched C₁ to C₁₀ alkyl group; m is an integer from 1 to about 250 in one aspect of the invention, 5 to 100 in another aspect, and 5 to about 25 in a further aspect; (R¹³O)ₘ is an alkylene oxide group (when m=1) or a poly(alkylene oxide) group (when m>1); and R¹³ independently represents a linear and branched divalent radical selected from —C₂H₄—, —C₃H₆—, and —C₄H₈—. It is to be noted that when m is greater than 1, e.g., 2 or more, the alkylene oxide groups can be the same or different and can form poly(alkylene oxide) homopolymers, random copolymers and block copolymers.

Fluorinated monoalcohols, such as, for example, those set forth in U.S. Pat. Nos. 6,506,806 and 6,764,984, the disclosures of which are herein incorporated by reference, are also suitable monoalcohol reactants in the formation of the RAFT ester adducts of the invention. In one aspect of the invention, fluorinated monoalcohols are selected from fluorinated aliphatic monoalcohols and fluorinated alkoxylated monoalcohols. In another aspect of the invention the fluorinated monoalcohols can be represented by the formula:

R_{f}—(CH₂)ₙ—O(R¹³O)ₘ—H

wherein m is an integer from 0 to about 250 in one aspect of the invention, 1 to 100 in another aspect, and 5 to about 25 in a further aspect n is an integer from 1 to 5; R_{f} represents an fluorinated hydrocarbon residue (hydrocarbyl) having from 1 to about 40 carbon atoms; (R¹³O)ₘ is an alkylene oxide group (when m=1) or a poly(alkylene oxide) group (when m>1); and R¹³ independently represents a linear and branched divalent radical selected from —C₂H₄—, —C₃H₆—, and —C₄H₈—. It is to be noted that when m is greater than 1, e.g., 2 or more, the alkylene oxide groups can be the same or different and can form poly(alkylene oxide) homopolymers, random copolymers and block copolymers. It is also noted that when m is 0, the oxyalkylene group is absent and the terminal hydrogen moiety is covalently bonded to the oxygen to form a terminal hydroxyl group. Exemplary fluorinated hydrocarbyl groups include but are not limited to fluorinated C₁ to C₄₀ alkyl, fluorinated C₆ to C₁₈ aryl, and fluorinated C₇ to C₂₄ aralkyl. Suitable fluorinated aliphatic monoalcohols can be represented by the formula:

R_{f}—(CH₂)ₙ—OH

wherein R_{f} is defined as above and n is an integer of 1 to 5. Exemplary fluorinated aliphatic monoalcohols include, but are not limited to 1H, 1H-perfluoro-1-butanol, 1H, 1H-perfluoro-1-hexanol, 1H, 1H-perfluoro-1-octanol, 1H, 1H-perfluoro-1-nonanol, 1H, 1H-perfluoro-1-decanol, 1H, 1H-perfluoro-1-undecanol, 1H, 1H-perfluoro-1-dodecanol, and 1H, 1H-perfluoro-1-tetradecanol. Fluorinated aliphatic monoalcohols are commercially available from Exfluor Research Corporation, Round Rock, Tex. and available from E.I. du Pont de Nemours and Company under the Zonyle trade name. (e.g., product designations BA, BA-LD).

Exemplary fluorinated alkoxylated monoalcohols are represented by the formula:

R_{f}—(CH₂)ₙ—O(CH₂CH₂O)ₓ—H

wherein R_{f} is defined as above, n is an integer of 1 to 5, and x is an integer from about 2 to 20. Fluorinated alkoxylated monoalcohols are commercially available from E.I. du Pont de Nemours and Company under the Zonyl® trade name. (e.g., product designations FSO, FSN, and FS 300).

By the term “fluorinated” as used here and throughout the specification is meant that one or more hydrogen substituents on the hydrocarbon residue are replaced by fluorine atoms. The degree of fluorination can range from at least one hydrogen atom being replaced by a fluorine atom (e.g., a monofluoromethyl group) to full fluorination (perfluorination) wherein all hydrogen atoms on the hydrocarbyl group have been replaced by a halogen atom (e.g., perfluorocarbyl such as trifluoromethyl or perfluoromethyl). The fluorinated hydrocarbyl and perfluorocarbyl groups contain, in one aspect of the invention, 1 to 40 carbon atoms. In another aspect, the fluorinated hydrocarbyl and perfluorocarbyl groups contain 1 to 20 carbon atoms. In yet another aspect, the fluorinated hydrocarbyl and perfluorocarbyl groups contain 6 to 10 carbon atoms and can be linear and branched, saturated or unsaturated, cyclic, or aromatic. The fluorinated hydrocarbyl and perfluorocarbyl groups include but are not limited to fluorinated and perfluorinated linear and branched C₁ to C₄₀ alkyl, fluorinated and perfluorinated C₃ to C₂₄ cycloalkyl, fluorinated and perfluorinated C₂ to C₄₀ alkenyl, fluorinated and perfluorinated C₃ to C₂₄ cycloalkenyl, fluorinated and perfluorinated C₆ to C₂₄ aryl, and fluorinated and perfluorinated C₇ to C₂₄ aralkyl.

Polysiloxane monoalcohols such as, for example, monohydroxyl terminated polysiloxane are suitable monoalcohols for reaction with the RAFT reagent in the formation of the RAFT ester adducts of the invention. As used here and throughout the specification the term “polysiloxane” means a polymer comprising organosiloxane repeating units based on the structural unit —[(R¹⁵)(R¹⁶)SiO]ₚ—, wherein R¹⁵ and R¹⁶ independently represent an organo substituent, such as for example, hydrogen, hydrocarbyl and substituted hydrocarbyl; and n is an integer from 1 to 1000. In one aspect of the invention the hydrocarbyl group is independently selected from C₁ to C₁₀ alkyl, C₆ to C₁₄ aryl, C₃ to C₈ cycloalkyl, and C₇ to C₁₈ aralkyl. When substituted, the hydrocarbyl group contains substituents selected from C₁ to C₅ alkyl, haloalkyl containing 1 to 5 carbon atoms (wherein one or more hydrogen atoms is substituted with a halogen atom selected from bromine, chlorine, fluorine, iodine, and combinations thereof), phenyl, halophenyl (wherein one or more hydrogen atoms is substituted with a halogen atom selected from bromine, chlorine, fluorine, iodine, and combinations thereof), and halogen (e.g., bromine, chlorine, fluorine, iodine). In one aspect of the invention, R¹⁵ and R¹⁶ are substituted or unsubstituted and independently represent methyl, ethyl, propyl, butyl, hexyl, and the like; cyclopentyl, cyclohexyl, and the like; phenyl, benzyl, and phenylethyl, and the like, wherein if substituted the substituents are defined as immediately above.

In another aspect of the invention, the polysiloxane monoalcohol can be represented by the formula below:

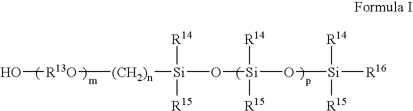

wherein m is an integer from 0 to about 250 in one aspect of the invention, 1 to 100 in another aspect, and 5 to about 25 in a further aspect; n is an integer from 1 to 10 in one aspect and 3 to 5 in another aspect; p is an integer from 0 to about 1000 in one aspect, 1 to 250 in another aspect, and 5 to about 100 in a further aspect; (R¹³O)ₘ is an alkylene oxide group (when m=1) or a poly(alkylene oxide) group (when m>1); and R¹³ independently represents a linear and branched divalent radical selected from —C₂H₄—, —C₃H₆—, and —C₄H₈—. It is to be noted that when m is greater than 1, e.g., 2 or more, the alkylene oxide groups can be the same or different and can form poly(alkylene oxide) homopolymers, random copolymers and block copolymers; R¹⁴ and R¹⁵ independently represent a radical selected from C₁ to C₃₀ alkyl, C₃ to C₈ cycloalkyl, and C₆ to C₁₄ aryl. It is noted that when m is 0, the oxyalkylene group is absent and the terminal hydroxyl group is covalently bonded to the terminal carbon atom in the alkanediyl moiety. In one aspect of the invention R¹⁴ and R¹⁴ are each methyl.

Polysiloxane monoalcohols conforming to the formula above are commercially available from Gelest, Inc. under product designations MCR-12, MCR-13, MCR-18, and MCR-22.

The term “polyol” denotes any compound having an average of about two or more hydroxyl groups per molecule. In one aspect of the invention the hydroxyl group can be a primary and/or a secondary alcohol. In another aspect of the invention a hydroxyl group is located at a terminal end of the polyol. In still another aspect, a hydroxyl group is located at each terminal end of the polyol. Examples of polyols that can be used in the present invention include simple polyols (e.g., monomeric) and complex (e.g., polymeric) polyol compounds. For brevity, dimeric polyols are listed with the monomeric polyol compounds. Any polyol available to one of ordinary skill in the art is suitable for use according to the invention. In one aspect of the invention, the simple polyols that can be reacted with the foregoing RAFT reagents to form the RAFT ester adducts can be represented by the formula:

HO—R¹⁸—(OH)ₙ

wherein n is an integer from 1 to about 25 in one aspect, 2 to 25 in another aspect; and 3 to 10 in a further aspect; and R¹⁸ is a substituted or unsubstituted hydrocarbon containing organic moiety. In one aspect of the invention, no two hydroxyl groups are situated on the same carbon atom. In another aspect of the invention, a hydroxyl group is situated on a terminal end of the hydrocarbon moiety. In a further aspect of the invention, the polyol is a diol, triol or tetrol. In another aspect of the invention, R¹⁸ is selected from a linear and branched, substituted and unsubstituted hydrocarbon moiety containing 2 to 200 carbon atoms, optionally containing heteroatoms and/or hetero groups selected from carbonyl, oxygen, nitrogen, sulfur, phosphorous, and combinations thereof; a substituted and unsubstituted cycloalkanediyl moiety containing 3 to 10 carbon atoms; a substituted and unsubstituted arenediyl moiety containing 6 to 24 carbon atoms, optionally containing heteroatoms selected from oxygen, nitrogen, sulfur, and combinations thereof. When the foregoing moieties are substituted, the substituents are independently selected from linear and branched C₁ to C₆ alkyl, C₁ to C₂₀ alkoxy, C₆ to C₁₄ aryl, halogen (e.g., chlorine, bromine, fluorine, and iodine), cyano, nitro, and combinations thereof.

Exemplary simple polyols include but are not limited to ethylene glycol; 1,2- and 1,3-propylene glycol; 1,2-, 1,3-, 1,4-, and 2,3-butylene glycols; neopentyl glycol; 2-methyl-1,3-propanediol; 2,2,4-trimethyl-1,3-pentanediol; triethylene glycol; tetraethylene glycol; 1,6-hexanediol; 1,8-octanediol; dipropylene glycol; dibutylene glycol; caprolactone diol; dimerate diol; trimethylol propane; cyclohexane diols and triols (all isomers, e.g., 1,4-cyclohexane diol); cyclohexane dimethanol and trimethanol (all isomers, e.g., 1,4-bis-hydroxymethylcyclohexane); pentaerythritol; di-pentaerythritol, and di-trimethylolpropane; monosaccharides such as, for example, sorbitol, mannitol, fructose, glucose, galactose, mannose, ribose; disaccharides such as, for example, sucrose, lactose, and maltose.

Exemplary complex or polymeric polyols include but are not limited to polyester polyols; polyether polyols; polycarbonate polyols; polycaprolactone polyols; polyurethane diols; fluoropolyether diols; fluorinated alkane diols; polyorganosiloxane polyols, alkoxylated polyorganosiloxane polyols; vegetable oil derived polyols; hyperbranched polyols; graft polymer polyols; polybutadiene polyols; hydrogenated polybutadiene polyols; and natural and synthetic polysaccharides. In one aspect of the invention, polyester polyols, polyether polyols, polycarbonate polyols, polysiloxane polyols, and alkoxylated polysiloxane polyols are utilized.

The polyester polyols typically are esterification products prepared by the reaction of organic polycarboxylic acids, such as, for example, a dicarboxylic acid, or their anhydrides with a stoichiometric excess of a diol. For exemplary purposes, the diols that can be used in making the polyester polyols include alkylene glycols, e.g., ethylene glycol, 1,2- and 1,3-propylene glycols, 1,2-, 1,3-, 1,4-, and 2,3-butylene glycols, hexane diols, neopentyl glycol, 1,6-hexanediol, 1,8-octanediol, and other glycols such as bisphenol-A, cyclohexane diol, cyclohexane dimethanol (1,4-bis-hydroxymethylcycohexane), 2-methyl-1,3-propanediol, 2,2,4-trimethyl-1,3-pentanediol, diethylene glycol, triethylene glycol, tetraethylene glycol, polyethylene glycol, dipropylene glycol, polypropylene glycol, dibutylene glycol, polybutylene glycol, dimerate diol, hydroxylated bisphenols, polyether glycols, halogenated diols, and the like, and mixtures thereof. Preferred diols include ethylene glycol, diethylene glycol, butylene glycol, hexane diol, and neopentyl glycol.

Exemplary carboxylic acids used in making the polyester polyols include dicarboxylic acids and tricarboxylic acids and anhydrides, e.g., maleic acid, maleic anhydride, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, the isomers of phthalic acid, phthalic anhydride, fumaric acid, dimeric fatty acids such as oleic acid, and the like, and mixtures thereof. Preferred polycarboxylic acids used in making the polyester polyols include aliphatic or aromatic dibasic acids.

In one aspect of the invention the polyester polyol is a diol. Exemplary polyester diols include poly(butanediol adipate); hexane diol adipic acid and isophthalic acid polyesters such as hexane adipate isophthalate polyester; hexane diol neopentyl glycol adipic acid polyester diols, e.g., Piothane™ 67-3000 HNA (available from Panolam Industries) and Piothane 67-1000 HNA polyester polyols; as well as propylene glycol maleic anhydride adipic acid polyester diols, e.g., Piothane 50-1000 PMA; and hexane diol neopentyl glycol fumaric acid polyester diols, e.g., Piothane 67-500 HNF. Other preferred polyester diols include Rucoflex® S1015-35, S1040-35, and S-1040-110 (available from Bayer Material Science LLC).

Another class of polyester polyol suitable for use as the hydroxyl-containing compound includes the polycaprolactone polyols. Polycaprolactone polyols are commercially known compositions and can be produced by the ring-opening polymerization of an excess of caprolactone with various polyfunctional initiators, such as, for example, polyols, polyamines, amino alcohols, hydroxy carboxylic acids, and amino carboxylic acids. In one aspect of the invention the initiator is selected from a diol, triol or higher polyol initiator. The initiator can be monomeric or polymeric. Exemplary monomeric diol initiators include, for example, ethylene glycol, diethylene glycol, triethylene glycol, 1,2-propylene glycol, dipropylene glycol, 1,3-propylene glycol, neopentyl glycol, 1,4-butanediol, 1,6-hexane diol, 3-methyl-1,5-pentanediol, cyclohexanediol, 4,4′-methylenebiscyclohexanol, 4,4′-isopropylidene-biscyclohexanol, xylendiol, and 2-(4-hydroxymethylphenyl)-ethanol. Exemplary monomeric triols include, for example, glycerol, trimethylolpropane, and 1,2,6-hexanetriol. Higher polyol initiators include tetrols, such as, for example, erythritol, pentaerythritol, and the like. Exemplary polymeric diols include, for example, polyethylene glycol, polypropylene glycol, and poly(ethylene/propylene) glycols. In one aspect of the invention, the polymeric diols can contain from 2 to 250 of the respective alkylene oxide units, 5 to 100 in another aspect, and 5 to 25 in a further aspect. The ethylene oxide and propylene oxide repeating units in the poly(ethylene/propylene) glycols can be arranged in random or in block configuration. Representative polycaprolactone polyols are available under the Tone™ series of polyols (from The Dow Chemical Company) and Poly-T™ polyols (from Arch Chemicals, Inc.).

Polyether polyols are obtained in the known manner, such as, for example, by the reaction of (A) starting compounds that contain reactive hydrogen atoms, such as water or the diols set forth for preparing the polyester polyols, and (B) alkylene oxides, such as, for example, ethylene oxide, propylene oxide, epichlorohydrin, 1,2-butylene oxide, tetrahydrofuran, and the like, and mixtures thereof. In one aspect of the invention, exemplary polyethers include poly(ethylene glycol), poly(propylene glycol), polytetrahydrofuran, and block copolymers of ethylene glycol and propylene glycol wherein the ethylene and propylene oxide blocks can be in any order. Representative polyethers have the following structure:

HO—(R¹³O)ₘ—H

m is an integer from 1 to about 250 in one aspect of the invention, 2 to 50 in another aspect, and 2 to about 25 in a further aspect; (R¹³O)ₘ is an alkylene oxide group (when m=1) or a poly(alkylene oxide) group (when m>1); and R¹³ independently represents a linear and branched divalent radical selected from —C₂H₄—, —C₃H₆—, and —C₄H₈—. It is to be noted that when m is greater than 1, e.g., 2 or more, the alkylene oxide groups can be the same or different and can form poly(alkylene oxide) homopolymers, random copolymers and block copolymers. Useful commercially available polyether polyols include but are not limited to the Carbowax™ series of poly(ethylene glycol) polyols (available from The Dow Chemical Company); the Arcol® series of poly(propylene glycol) polyols (available from Bayer Material Science LLC); and the Pluronic® series of block copolymers of poly(ethylene glycol) and poly(propylene glycol) (available from BASF Corporation).

Polycarbonate polyols include those obtained from the reaction of (A) a carbonate ester or phosgene with (B) a polyol. Synthesis can be carried out by well known methods, such as, for example, by an ester interchange reaction between the carbonate ester and a stoichiometric excess of the polyol to obtain the hydroxyl terminated polycarbonate. Suitable carbonate esters include but are not limited to C₁ to C₁₀ dialkylcarbonates, an alkylene carbonate containing 3 to 5 carbocyclic atoms optionally substituted by C₁ to C₅ alkyl groups, and C₆ to C₁₈ diarylcarbonates optionally substituted by C₁ to C₅ alkyl groups. The dialkyl carbonates, alkylene carbonates, and diaryl carbonates include but are not limited to dimethyl carbonate, diethyl carbonate, di-n-butyl carbonate, di-iso-butyl carbonate, diphenyl carbonate, ethylene carbonate, propylene carbonate, butylene carbonate, 1,2-propylene carbonate, 1,2-butylene carbonate, 1,3-butylene carbonate, 2,3-butylene carbonate, 1,2-pentylene carbonate, 1,3-pentylene carbonate, 1,4-pentylene carbonate, 1,5-pentylene carbonate, 2,3-pentylene carbonate and 2,4-pentylene carbonate.

Examples of polyols which can be used in the preparation of the polycarbonate polyols include, but are not limited to ethylene glycol; propylene glycol, 1,3-propanediol, 2,2-dimethyl-1,3-propanediol, 1,2-butanediol, 1,4-butanediol, 1,3-butanediol, 1,5-pentanediol, 2,4-pentanediol; 2,2,4-trimethyl-1,3-pentanediol, 2-methyl-1,3-pentanediol, 2-methyl-1,5-pentanediol, 3-methyl-1,5-pentanediol, 1,6-hexanediol; 2,5-hexanediol; 2-ethyl-1,3-hexanediol; 1,4-cyclohexanediol; 1,7-heptanediol; 2,4-heptanediol; 1,8-octanediol; 1,9-nonanediol; 1,10-decanediol; 2,2-dimethyl-3-hydroxypropyl-2,2-dimethyl-3-hydroxypropionate; diethylene glycol; triethylene glycol; tetraethylene glycol; dipropylene glycol; tripropylene glycol; polypropylene glycol; 1,4-cyclohexanedimethanol; 1,2-bis(hydroxymethyl)cyclohexane; 1,2-bis(hydroxyethyl)cyclohexane; bisphenol-A, trimethylolethane; trimethylolpropane; di(trimethylolpropane)dimethylol propionic acid; and the polyether polyols described above.

Hydroxyl-terminated polybutadiene (including the partially and fully hydrogenated derivatives thereof) are linear polybutadiene polymers terminated with primary hydroxyl groups. They commercially available from Sartomer Company under the Krasol® trade name series of products.

Graft polymer polyols can be prepared by polymerizing free radically polymerizable vinyl monomer, such as, for example, styrene and/or acrylonitrile in the presence of a base polyol, such as, for example, the polyether polyols described hereinabove, and a free radical catalyst. During the reaction, graft polymerization of the vinyl monomer(s) onto the polyol base polymer backbone occurs. In addition, a homopolymer(s) and/or a copolymer is formed depending on the number of vinyl monomers employed in the polymerization. A stable polyol dispersion is formed comprising the hydroxyl-terminated grafted polyol base polymer, vinyl homopolymer and/or vinyl copolymer, and un-grafted base polyol. Grafted polyether polyols with poly(styrene/acrylonitrile) are commercially available from BASF Corporation and Shell Chemical LP under the Plurcol® series and Cardaol® series trade names, respectively.

Vegetable oil derived polyols are well known in the art and can be obtained from the epoxidation or hydroformylation of unsaturated vegetable oils. Polyunsaturated vegetable oil can be epoxidized by reaction with a peracid such as peracetic acid or other similar acids. The corresponding polyol is made by subjecting the epoxidized vegetable oil to ring-opening using acid catalysis such as mineral acids (e.g., sulfuric, hydrochloric) or organic acids (e.g., sulfonic). Alternatively, the polyunsaturation in the vegetable oil can be hydroformylated via hydroformylation catalysis (e.g., CO/H₂ or Rh/P) to form a polyadehyde followed by reduction of the aldehyde groups to the corresponding alcohol (polyol). Examples of vegetable oils that may be used include, but are not limited to, soybean oil, safflower oil, linseed oil, corn oil, sunflower oil, olive oil, canola oil, sesame oil, cottonseed oil, palm oil, rapeseed oil, tung oil, and mixtures thereof. Vegetable oil polyols are commercially available, such as those marketed by BioBased Technologies under the Argrol™ trade name. Soybean based polyols are available from Urethane Soy Systems Co. Inc. under the Soyol™ trade name.

Fluorinated polyols such as, for example, fluorinated aliphatic diols and fluorinated polyether diols conforming to the following formula can be utilized in the formation of the RAFT ester adducts of the invention:

HO-A¹-R^{f}-A²-OH

wherein A¹ and A² independently are monomeric or polymeric optionally fluorinated divalent radicals selected from alkanediyl, arenediyl, alkylene oxide, and arylene oxide, and combinations thereof; and R^{f} is a monomeric or polymeric fluorinated divalent moiety selected from fluorinated alkanediyl, fluorinated alkylene oxide, fluorinated arenediyl, and combinations thereof. The term “fluorinated” is as defined previously. In one aspect of the invention, the alkanediyl and fluorinated alkanediyl groups contain 1 to 25 carbon atoms. In one aspect of the invention, the arenediyl and fluorinated arenediyl groups contain 6 to 24 carbon atoms. In another aspect of the invention, the alkylene oxide and fluorinated alkylene oxide groups contain 2 to 4 carbon atoms.

Exemplary fluorinated aliphatic diols can be represented by the formula:

HO—CH₂—(CF₂)ₙ—CH₂—OH

wherein n is an integer ranging from 1 to about 20. Representative fluorinated aliphatic diols can be selected from but not limited to 1H,1H,4H,4H-perfluoro-1,4-butane diol, 1H,1H,5H,5H-perfluoro-1,5-pentane diol, 1H,1H,6H,6H-perfluoro-1,6-hextane diol, 1H,1H,8H,8H-perfluoro-1,8-octane diol, 1H,1H,9H,9H-perfluoro-1,9-nonane diol, 1H,1H,10H,10H-perfluoro-1,10-decane diol, 1H,1H,12H,12H-perfluoro-1,12-dodecane diol, and 1H,1H,16H,16H-perfluoro-1,16-hexadecane diol. Fluorinated aliphatic diols are commercially available from Exfluor Research Corporation, Round Rock, Tex.

In the polyether and fluorinated polyether embodiments, the alkylene oxide groups can be the same or different and can form poly(alkylene oxide) homopolymers, random copolymers and block copolymers as well as the fluorinated derivatives thereof. In one aspect the fluorinated polyether (e.g., poly(alkylene oxide)) diols of the invention can be represented by the formulae:

HOCH₂CF₂O(CF₂CF₂O)ₙCF₂CH₂OH; A)

HOCH₂CF₂CF₂O(CF₂CF₂CF₂O)ₙCF₂CF₂CH₂OH; B)

HOCH₂CF₂CF₂CF₂O(CF₂CF₂CF₂O)ₙCF₂CF₂CF₂CH₂OH; C)

HOCH₂CF₂O(CF₂CF₂O)ₘ(CF₂CF₂CF₂CF₂O)ₙ(CF₂CF₂O)ₙCF₂CH₂OH; and D)

HOCH₂CF₂O(CF₂CF₂O)ₘ(CF₂CF₂CF₂O)ₙ(CF₂CF₂O)ₙCF₂CF₂O—(CF₂CF₂CF₂O)ₙ(CF₂CF₂O)ₘCF₂CH₂OH E)

wherein m and n are integers representing the number of alkylene oxide repeating units. In one aspect of the invention, m and n independently represent and integer ranging from 0 to about 250, subject to the proviso that the sum of m+n ranges from 1 to about 250. Fluorinated aliphatic diols and fluorinated polyether diols are disclosed in U.S. Pat. No. 7,078,445, which is herein incorporated by reference. Fluorinated polyether diols are commercially available from Solvay Solexis, Inc. under the Fluorolink® trade name.

Hydroxyl-terminated hyperbranched polyester polyols are dendritic polymers containing a multiple array of polyester branches terminated with a primary hydroxyl group. The branches are attached to a monomeric or polymeric core molecule. Such polyols are described in U.S. Pat. Nos. 5,418,301 and 5,663,247 which are herein incorporated by reference. Specific examples of hydroxyl-terminated hyperbranched polyester polyols with varying hydroxyl functionality are available from Perstorp Polyols, Inc. under the Boltorn® trade name. Boltorn product designations H2003 (hydroxyl functionality equals 12), H20 (hydroxyl functionality equals 16), H30 (hydroxyl functionality equals 32), H40 (hydroxyl functionality equals 64), and H50 (hydroxyl functionality equals 128), are examples of commercially available hydroxyl-terminated hyperbranched polyols.

Polysiloxane polyols such as represented by the Formulae II, III, IV, and V below also are useful in the formation of the RAFT ester adducts of the invention. In one aspect of the invention, such polyols contain at least two hydroxyl groups which can be situated on the terminal ends of the polymer (Formulae II and IV), or which can be situated on the organosiloxane repeating unit of the polymer (Formula II). In another aspect of the invention the hydroxyl groups can be situated at the terminal ends of a short hydrocarbon chain with a polyorganosiloxane side chain pending therefrom (Formula V).

In one aspect the invention, an exemplary polysiloxane polyol having terminal hydroxyl substitution is represented by the formula:

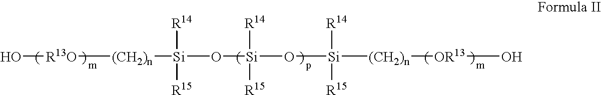

wherein m; n; p; R¹³; R¹⁴; R¹⁵; and (R¹³O)ₘ are as defined under Formula I above. The integer value of m can be the same or different each time it is taken in the above formula and the integer value of n can be the same or different each time it is taken in the above formula. In one aspect of the invention R¹⁴ and R¹⁴ are each methyl.

Hydroxyl terminated alkoxylated polysiloxane polyols conforming to the above formula are commercially available from Gelest, Inc. under product designations DMS-C15, DMS-C16, DMS-C21, and DMS-C26.

In another aspect of the invention, the polyorganosiloxane polyol comprises siloxane repeating units wherein at least a portion of which are substituted with a hydroxyl group. These polyorganosiloxane polyols can be represented by the formula below.

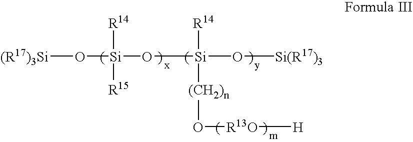

wherein m; n; R¹³; R¹⁴; R¹⁵; and (R¹³O)ₘ are as defined in Formula I above; x is an integer from 0 to about 200; y is an integer from 1 to about 200; and R¹⁷=R¹⁴ and can be the same or different each time it is taken. In one aspect of the invention R¹⁴, R¹⁴, and R¹⁷ are each methyl.

Hydroxyl containing alkoxylated polysiloxane polyols conforming to the above formula are commercially available from Gelest, Inc. under product designations CMS-222 and CMS-626.

In addition, the polyorganosiloxane polyols described under Formulae II and are also commercially available under the Silsoft® and Silwet® trade names from the General Electric Company (GE-OSi) and the DC series of products from Dow Corning Corporation. Specific product designations include but are not limited to Silsoft 305, 430, 475, 810, 895, Silwet L 7604 (GE-OSi) and DC 5103 (Dow Corning Corporation).

In another aspect of the invention, a hydroxyl terminated polysiloxane conforming to the formula below is useful in the formation of the RAFT ester adducts.

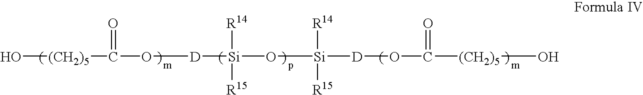

wherein D is a divalent radical selected from —(CH₂)ₙ— and —(R¹³O)ₘ—(CH₂)ₙ—, wherein the —(CH₂)ₙ— moiety in the —(R¹³O)ₘ—(CH₂)ₙ— radical is bonded to the Si atom; and m; n; p; R¹³; R¹⁴; R¹⁵; and (R¹³O)ₘ are as previously defined in Formula I. D, m, and n can be the same or different.

Hydroxyl terminated polyorganosiloxane polyols conforming to the above formula are commercially available from Gelest, Inc. under product designation DBL-C31.

In a further aspect of the invention, the polyorganosiloxane polyol is a hydroxyl terminated alkane diol with a pendant polyorganosiloxane side chain as shown in the formula below.

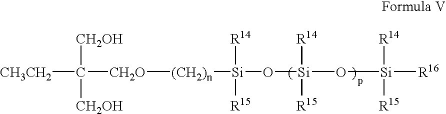

wherein n; p; R¹⁴; R¹⁵; and R¹⁶ are as previously defined under Formula I.

The polyorganosiloxane polyols conforming to the above formula are commercially available from Gelest, Inc. under product designations MCR-C61 and MCR-C62.

Hydroxyl terminated star polyols comprising multiple hydroxyl terminated polymer arms covalently bonded to a central core molecule are widely known. The central core molecule is a residue of an initiator core polyol having at least 3 reactive hydroxyl groups available for preformed polymer arm attachment or in situ polymer arm formation. The initiator core polyol contains the number of hydroxyl groups equal to the number of desired polymer arms. The polymer arms of the star polyols comprise a residue of poly(hydroxylesters), poly(alkylene oxides), and block copolymers of poly(hydroxylesters) and poly(alkylene oxides). The star polyols can schematically be represented as follows.

CORE[(polymer arm)-OH]ₓ

wherein CORE is a residue of an initiator polyol having at least three terminal hydroxyl groups, (polymer arm) represents a residue of a hydroxy terminated polymer selected from a poly(hydroylester), poly(alkylene oxide), and combinations thereof, and x represents the number of the hydroxyl terminated polymer arms covalently attached to the CORE. In one aspect of the invention x is an integer of at least 3. In another aspect x ranges from 3 to about 25, and in a further aspect can range from 3 to about 8.

Exemplary initiator core polyols include but are not limited to glycerol, trimethylolpropane, cyclohexane triol (including all positional isomers), cyclohexane trimethanols (including all positional isomers), pentaerythritol, ditrimethylolpropane, dipentaerythritol, sorbitol, mannitol, and hydroxypropyl-β-cyclodextrin.

Exemplary poly(hydroxylesters) include but are not limited to poly(lactide), poly(glycolide), poly(lactide/glycolide) copolymer, poly(butryolactide), poly(caprolactone), and poly(adipic anhydride).

Exemplary polyethers include but are not limited to poly(ethylene oxide), poly(propylene oxide), poly(butylene oxide) and copolymers thereof.

The star polyols can be prepared by covalently attaching coreactive preformed polymer arms to the core initiator polyol via the hydroxyl groups on the core initiator. Alternatively the polymer arms can be prepared by directly polymerizing monomer repeating units on the core initiator via ring-opening polymerization techniques utilizing the core initiator hydroxyl groups as initiating points. Block copolymer arms can be formed by attaching or polymerizing a hydroxyl terminated first polymer segment on the initiator polyol followed by attaching or polymerizing a second polymer segment onto the first polymer segment utilizing the terminal hydroxyl group on the first polymer segment a the initiating point for the second polymer segment. Such methods are well known in the art as disclosed in U.S. Pat. Nos. 7,009,033 and 6,730,334.

The branched architecture can be synthesized by alkoxylating the potassium salt of multifunctional core polyol initiators including glycerol, I, sorbitol or any other suitable multifunctional polyol with alkylene oxide such as ethylene oxide and/or propylene oxide. These initiator polyols generate three-, four-, six-, eight-, or multi-arm hydroxyl terminated star polymers respectively. Other suitable initiator polyols include the potassium salt derived from the multifunctional simple polyols containing at least 3 hydroxyl moieties set forth previously above. Such multifunctional polyols include trimethylol propane, ditrimethylol propane, cyclohexane triols, cyclohexane trimethanols, mannitol, and the like.

The architecture of these branched polymers is schematically illustrated below:

CORE[(R¹³O)ₘ—H]ₓ

wherein CORE represents a central core based on the initiator polyol and is a residue of a multifunctional polyol containing at least three terminal hydroxyl groups, and x represents the number of the hydroxyl terminated arms emanating from the CORE. In one aspect of the invention x can range from 3, 4, 6, 8, or more.

Polyurethane polyols are polyol compounds having urethane linkages and can be obtained by the reaction of a polyol with an organic polyisocyanate. The compositions of the present invention are conveniently referred to as polyurethanes because they contain a urethane group(s). It is well understood by those skilled in the art that “polyurethane” is a generic term used to describe polymers obtained by reacting at least one polyisocyanate with at least one hydroxyl-containing compound, amine-containing compound, or mixture thereof. In one aspect of the invention a hydroxyl terminated urethane or polyurethane polyol oligomer or prepolymer can be utilized as the polyol reactant in the formation of the RAFT ester adduct.

In the formation of the hydroxyl terminated urethane prepolymer polyol, a stoichiometric excess of a polyol is reacted with a polyisocyanate compound to ensure that the resultant product contains free hydroxyl functionality. In this embodiment, the amount of the hydroxyl functionality to isocyanate functionality is selected so that the OH/NCO equivalent ratio in the reaction medium is greater than 1. In one aspect of the invention the OH/NCO equivalent ratio is above about 1.3, in another aspect the OH/NCO equivalent ratio is above about 1.5, 1.7, 1.9, 2.0, 2.3, and in a further aspect about 2.5. In still another aspect the OH/NCO equivalent ratio can range from above about 1.0 to about 2.3, and in still a further aspect from 1.3 to about 2.5.

Another method for producing the hydroxyl terminated urethane prepolymer is through the two step procedure of first forming an isocyanate terminated prepolymer and then converting the isocyanate terminated prepolymer to a hydroxyl terminated polyurethane by reacting the isocyanate terminated polyurethane prepolymer with a chain terminator, generally a hydroxyl containing amine, such as an alkanolamine. In the first step of the procedure, a stoichiometric excess of the polyisocyanate is reacted with the polyol to ensure that the resultant product contains free NCO functionality. In one aspect, the amount of isocyanate functionality to hydroxyl functionality is selected so that the NCO/OH equivalent ratio is above about 1.3, in another aspect the NCO/OH equivalent ratio is above about 1.5, 1.7, 1.9, 2.0, 2.3, and in a further aspect about 2.5. In still another aspect the NCO/OH equivalent ratio can range from above about 1.0 to about 2.3, and in still a further aspect from 1.3 to about 2.5. In the second step of the reaction, the isocyanate terminated prepolymer is reacted with a stoichiometric excess of the alkanolamine chain terminator. The amine hydrogen is much more reactive with the isocyanate group than is the hydroxyl group. As a result, hydroxyl functionality is incorporated into the polyurethane prepolymer to obtain the hydroxyl terminated polyurethane. Examples of hydroxylamines suited for chain terminating the isocyanate terminated polyurethane prepolymer and converting the isocyanate terminated polyurethane prepolymer to a hydroxyl terminated polyurethane prepolymer include, but are not limited to, C₂ to C₁₀ alkanolamines such as ethanolamine, propanolamine, butanolamine, diethanolamine, di-n-propanolamine, di-n-butanolamine, and dicyclohexanolamine.

Chain extenders, such as, for example, primary diamines can be utilized in the two step process set forth above to chain extend the isocyanate terminated prepolymer prior to chain termination with the alkanolamine resulting in higher molecular weight products.

The organic polyisocyanate which can be used in preparing the polyurethane polyols can be an aliphatic or aromatic polyisocyanate or mixtures thereof. The polyisocyanate reactant is selected from a polyisocyanate containing at least two reactive isocyanate groups, such as a diisocyanate, triisocyanate or a higher polyisocyanate containing compound.

Specific examples of suitable aliphatic polyisocyanates include but are not limited to α,ω-alkylene diisocyanates having from 5 to 20 carbon atoms, such as 1,4-tetramethylene diisocyanate, 1,6-hexamethylene diisocyanate, 1,10-decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity.

Specific examples of suitable cycloaliphatic polyisocyanates contain from about 6 to 20 carbon atoms and include but are not limited to cyclobutane-1,3-diisocyanate, dicyclohexylmethane diisocyanate, (commercially available as Desmodur™ W from Bayer Corporation), isophorone diisocyanate, 1,2-cyclohexane diisocyanate, 1,3-cyclohexane diisocyanate, 1,4-cyclohexane diisocyanate, 2,4-methylcyclohexane diisocyanate, 4,4′-dicyclohexydiisocyante, 2,4′-dicyclohexydiisocyante, 3-bis-(isocyanatomethyl)cyclohexane, 1,3,5-cyclohexan triisocyanate, isocyanatomethylcyclohexane isocyanate, 4,4′-bis(isocyanatomethyl)dicyclohexane, 2,4′-bis(isocyanatomethyl)dicyclohexane, including dimers and trimers thereof, and combinations thereof.

Examples of suitable aromatic polyisocyanates include but are not limited to polyisocyanates that from about 8 to about 20 carbon atoms and include 2,4-hexahydrotoluenediisocyanate, 2,6-hexahydrotoluenediisocyanate, 1,2-phenylene diisocyanate, 1,3-phenylene diisocyanate, 1,4-phenylene diisocyanate, triphenyl methane-4,4′,4″-triisocyanate, naphthylene-1,5-diisocyanate, 2,4-toluene diisocyanate, 2,6-toluene diisocyanate, 2,4′-biphenyl diisocyanate, 4,4′-biphenyl diisocyanate, 2,2-biphenyl diisocyanate, 2,2′-diphenylmethane diisocyanate, 2,4′-diphenylmethane diisocyanate, 4,4′-diphenylmethane diisocyanate, m-tetramethyl xylylene diisocyanate, p-tetramethyl xylylene diisocyanate, 1,4-xylylene diisocyanate, 1,3-xylylene diisocyanate, polyphenyl polymethylene polyisocyanates, and combinations thereof. Dimers and trimers of the foregoing polyisocyanates are also contemplated.

Methods of forming polyurethane polyols prepolymers have long been known in the art. The hydroxyl terminated polyurethane is typically prepared by the reaction of at least one compound selected from the polyisocyanate compounds and the polyols described above. An overview of polyurethane chemistry is set forth in Saunders, Polyurethanes: Chemistry and Technology, Wiley & Sons, 1961. In one aspect, the polyisocyanate and polyol are combined in the equivalent ratios set forth above and reacted in solvent in the optional presence of a catalyst. The reaction is carried out at elevated temperature of at least about 30° C. in one aspect, and at least 60° C. in another aspect. The reaction temperatures may be lower or higher depending on the particular reactants and on the amount of catalyst, if employed. The solvent utilized can be a suitable organic solvent, such as, for example, dioxane, xylene, cyclohexane, acetone, methylethyl ketone, N-methyl-2-pyrrolidone, and mixtures thereof. Suitable catalysts include stannous octoate, dibutyl tin dilaurate, and tertiary amine compounds such as triethylamine and bis-(dimethylaminoethyl)ether, morpholine compounds such as β,β′-dimorpholinodiethyl ether, bismuth carboxylates, zinc bismuth carboxylates, iron (III) chloride, potassium octoate, potassium acetate, and DABCO® (bicycloamine) from Air Products. The preferred catalyst is FASCAT® 2003 from Elf Atochem North America. The amount of catalyst used is typically from about 5 to about 200 parts per million of the total weight of prepolymer reactants.

In another aspect of the invention, a chain extended hydroxyl terminated polyurethane polyol can be utilized as the hydroxyl containing compound in the formation of the RAFT adduct.

Polysaccharides such as for example, polysaccharides obtained from tree and shrub exudates, such as gum arabic, gum gahatti, and gum tragacanth, as well as pectin; seaweed extracts, such as aliginates and carrageenans; algae extracts, such as agar; microbiological polysaccharides, such as xanthan, gellan, and wellan; cellulose ethers, such as ethylhexylethylcellulose (EHEC), hydroxybutylmethylcellulose (HBMC), hydroxyethylmethylcellulose (HEMC), hydroxypropylmethylcellulose (HPMC), methyl cellulose (MC), carboxymethylcellulose (CMC), hydroxyethylcellulose (HEC), and hydroxypropylcellulose (HPC); starches, such as corn starch, tapioca starch, rice starch, wheat starch, potato starch, and sorghum starch; and polygalactomannans such as, for example, those extracted from tamarind gum; fenugreek gum; cassia gum; locust bean gum; tara gum; and guar gum.

In a further embodiment, the carboxyl terminated thiocarbonate compounds are reacted with one or more, same or different, monomers through a reversible polymerization process, such as a reversible addition—fragmentation transfer (RAFT) polymerization, thereby incorporating the monomer(s) into the backbone of the thiocarbonate compound thus forming a polymer or copolymer which can react with hydroxyl-terminated polydimethylsiloxanes to form the block copolymer. Preferably, the macroinitiator from the adduct of the polyol and the thiocarbonate compounds are made and thereafter the conjugated diene and/or vinyl monomers are reacted into the thiocarbonate backbone.

The monomers include one or more conjugated diene monomers or one or more vinyl containing monomers, or combinations thereof. The various one or more free radically polymerizable monomer as well as the various reaction conditions thereof including types of initiators, catalysts, solvents, and the like are set forth in U.S. Pat. No. 6,596,889 granted Jul. 22, 2003; U.S. application Ser. No. 10/219,403 filed Aug. 15, 2002; U.S. application Ser. No. 10/278,335 filed Oct. 23, 2002; and U.S. application Ser. No. 10/681,679 filed Oct. 8, 2003, all of which are hereby fully incorporated by reference with regard to all aspects thereof.

The diene monomers have a total of from 4 to about 12 carbon atoms and examples include, but are not limited to, 1,3-butadine, isoprene, 1,3-pentadiene, 2,3-dimethyl-1-3-butadiene, 2-methyl-1,3-pentadiene, 2,3-dimethyl-1,3-pentadiene, 2-phenyl-1,3-butadiene, and 4,5-diethyl-1,3-octadiene, and combinations thereof.

The vinyl containing monomers have the following structure:

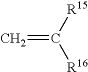

where R¹⁵ comprises hydrogen, halogen, C₁ to C₄ alkyl, or substituted C₁ to C₄ alkyl wherein the substituents, independently, comprise one or more hydroxy, alkoxy, aryloxy(OR¹⁷), carboxy, metal carboxylate (COOM) with M being sodium, potassium, calcium, zinc or the like or an ammonium salt, acyloxy, aroyloxy(O₂CR¹⁷), alkoxy-carbonyl(CO₂R¹⁷), or aryloxy-carbonyl; and R¹⁶ comprises hydrogen, R¹⁷, CO₂H, CO₂R¹⁷, COR¹⁷, CN, CONH₂, CONHR¹⁷, O₂CR¹⁷, OR¹⁷, or halogen. R¹⁷, independently, comprises C₁ to C₁₈ alkyl, substituted C₁ to C₁₈ alkyl, C₂ to C₁₈ alkenyl, aryl, heterocyclyl, aralkyl, or alkaryl, wherein the substituents independently comprise one or more epoxy, hydroxy, alkoxy, acyl, acyloxy, carboxy (and salts), sulfonic acid (and salts), alkoxy- or aryloxy-carbonyl, dicyanato, cyano, silyl, halo and dialkylamino. Optionally, the monomers comprise maleic anhydride, N-vinyl pyrrolidone, N-alkylmaleimide, N-arylmaleimide, dialkyl fumarate and cyclo-polymerizable monomers. Monomers CH₂═CR¹⁵R¹⁶ as used herein include C₁ to C₈ acrylates and methacrylates, acrylate and methacrylate esters, acrylic and methacrylic acid, styrene, a methyl styrene, C₁ to C₁₂ alkyl styrenes with substitute groups both either on the chain or on the ring, acrylamide, methacrylamide, N- and N,N-alkylacrylamide and methacrylonitrile, mixtures of these monomers, and mixtures of these monomers with other monomers. As one skilled in the art would recognize, the choice of comonomers is determined by their steric and electronic properties. The factors which determine copolymerizability of various monomers are well documented in the art. For example, see: Greenley, R. Z., in Polymer Handbook, 3^{rd} Edition (Brandup, J., and Immergut, E. H. Eds.) Wiley: New York, 1989 p II-53.

Specific monomers or comonomers include the following: methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methylstyrene, methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, styrene, functional methacrylates, acrylates such as glycidyl methacrylate, 2-hydroxyethyl methacrylate, hydroxypropyl methacrylate (all isomers), hydroxybutyl methacrylate (all isomers), N,N-dimethylaminoethyl methacrylate, N,N-diethylaminoethyl methacrylate, and triethyleneglycol methacrylate, itaconic anhydride, itaconic acid; metal salts such as but not limited to sodium and zinc of all monomeric acids, such as but not limited to, itaconic acid and 2-acrylamido-2-methyl-1-propanesulfonic acid, or the like; N-vinylimidazole, vinylpyridine N-oxide, 4-vinylpyridine carboxymethylbetaine, diallyl dimethylammonium chloride, p-styrenesulfonic acid, p-styrenecarboxylic acid, 2-dimethylaminoethyl acrylate and its alkyl/hydrogen halide salts, 2-dimethyl-aminoethyl methacrylate and its alkyl/hydrogen halide salts, N-(3-dimethyl-aminopropyl)acrylamide, N-(3-dimethylaminoprolyl)methacrylamide, diacetone acrylamide, 2-(acetoacetoxy)ethyl methacrylate, 2-(acryloyloxy)ethyl acetoacetate, 3-trialkoxysilylpropylmethacrylate (methoxy, ethoxy, isopropoxy, etc), glycidyl acrylate, 2-hydroxyethyl acrylate, hydroxypropyl acrylate (all isomers), hydroxybutyl acrylate (all isomers), N,N-diethylaminoethyl acrylate, triethyleneglycol acrylate, methacrylamide, N-methylacrylamide, N,N-dimethylacrylamide, N-tertbutylmethacrylamide, N—N-butylmethacrylamide, N-methylolmethacrylamide, N-ethylolmethacrylamide, N-tertbutylacrylamide, N—N-butyl-acrylamide, N-methylolacrylamide, N-ethylolacrylamide, vinyl benzoic acid (all isomers), diethylaminostyrene (all isomers), alpha-methylvinyl benzoic acid (all isomers), diethylamino alpha-methylstyrene (all isomers), p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxy-methylsilylpropyl methacrylate, diethoxymethylsilylpropyl methacrylate, dibutoxy-methylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropyl acrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl amiate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, butadiene, isoprene, chloroprene, ethylene, and propylene, and combinations thereof.

Preferred monomers are C₁ to C₁₈ acrylates; acrylic acid; C₁ to C₈ monoalkyl and dialkyl acrylamides; a combination of C₁ to C₈ acrylates and methacrylates; a combination of said acrylamides and C₁ to C₈ monoalkyl and dialkyl (meth)acrylamides; dimethylaminalkyl (meth)acrylates, (meth)acrylic acid, styrene; butadiene; isoprene and acrylonitrile.

Crosslinkers can be used in the polymerizations. Examples are triallyl pentaerythritol, allyl sucrose, hexanediacrylate, trimethylolpropane tri(meth)acrylate and the like.

In order to initiate the free radical polymerization process, it is often desirable to utilize an initiator as a source for initiating free radicals. Generally, the source of initiating radicals can be any suitable method of generating free radicals such as the thermally induced homolytic scission of a suitable compound(s) (thermal initiators such as peroxides, peroxyesters, or azo compounds), the spontaneous generation from monomer (e.g., styrene), redox initiating systems, photochemical initiating systems or high energy radiation such as electron beam, X— or gamma-radiation. The initiating system is chosen such that under the reaction conditions there is no substantial adverse interaction of the initiator or the initiating radicals with the transfer agent under the conditions of the experiment. The initiator should also have the requisite solubility in the reaction medium or monomer mixture. The thiocarbonate compounds of the invention can serve as an initiator, but the reaction must be run at a higher temperature. Therefore, optionally it is desirable to utilize an initiator other than the thiocarbonates compounds of the present invention.

Thermal initiators are chosen to have an appropriate half-life at the temperature of polymerization. All commercial and known initiators are believed to be suitable in this polymerization. These initiators can include one or more of the following compounds: 2,2′-azobis(isobutyronitrile)(AIBN), 2,2′-azobis(2-cyano-2-butane), dimethyl 2,2′-azobisdimethylisobutyrate, 4,4′-azobis(4-cyanopentanoic acid), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl)]-propionamide, 2,2′-azobis(N,N′-dimethyleneisobutyramidine)dihydrochloride, 2,2′-azobis(2-amidinopropane)dihydrochloride, 2,2′-azobis(N,N′-dimethyleneisobutyramine), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl] propionamide), 2,2′-azobis[2-methyl-N-(2-hydroxyethyl)propionamide], 2,2′-azobis(isobutyramide) dehydrate, 2,2′-azobis(2,2,4-trimethylpentane), 2,2′-azobis(2-methylpropane), t-butyl peroxyacetate, t-butyl peroxybenzoate, t-butyl peroxyoctoate, t-butylperoxy-neodecanoate, t-butylperoxy isobutyrate, t-amyl peroxypivalate, t-butyl peroxypivalate, di-isopropyl peroxydicarbonate, dicyclohexyl peroxydicarbonate, dicumyl peroxide, dibenzoyl peroxide, dilauroylperoxide, potassium peroxydisulfate, ammonium peroxydisulfate, di-t-butyl hyponitrite, dicumyl hyponitrite.

Photochemical initiator systems are chosen to have the requisite solubility in the reaction medium or monomer mixture and have an appropriate quantum yield for radical production under the conditions of the polymerization. Examples include benzoin derivatives, benzophenone, acyl phosphine oxides, and photo-redox systems production under the conditions of the polymerization; these initiating systems can include combinations of the following oxidants and reductants:
oxidants: potassium peroxydisulfate, hydrogen peroxide, t-butyl hydroperoxide
reductants: iron (11), titanium (111), potassium thiosulfate, potassium bisulfite.

Other suitable initiating systems are described in recent texts. See, for example, Moad and Solomon “The Chemistry of Free Radical Polymerization”. Pergamon, London. 1995. pp 53-95.

The preferred initiators of the present invention are 2,2′-azobis(isobutyronitrile)(AIBN), or 4,4′-azobis(4-cyanopentanoic acid), or 2,2′-azobis(2-cyano-2-butane), or 1,1′-azobis(cyclohexanecarbonitrile). The amount of initiators utilized in the polymerization process can vary widely as generally from about 0.001% to about 500%, and desirably from about 0.01% to about 50 or 75% based on the total moles of chain transfer agent utilized. Preferably small amounts are utilized from about 0.1% to about 5, 10, 15, 20, or 25 mole % based on the total moles of chain transfer agent utilized, i.e. said s,s′-bis-(α,α′-disubstituted-α″-acetic acid)-trithiocarbonate compounds or the Polyol-RAFT macroinitiator. In order to form polymers which are predominately telechelic, initiators other than the above thiocarbonate compounds are utilized in lesser amounts, such as from about 0.001% to about 5%, desirably from about 0.01% to about 4.5%, and preferably from about 0.1% to about 3% based on the molar equivalent to the total moles of chain transfer agent, or Polyol-RAFT macroinitiator utilized.

Optionally, as noted above, solvents can be utilized in the free radical polymerization process. Examples of such solvents include, but are not limited to, C₆ to C₁₂ alkanes, ethyl acetate, toluene, chlorobenzene, acetone, t-butyl alcohol, n-methylpyrrolidone, and dimethylformamide. The solvents are chosen so that they do not chain transfer themselves. The amount of solvent utilized in the present invention polymerization process is generally from about 10% to about 500% the weight of the monomer, and preferably from about 50% to about 200% the weight of the monomer utilized in the polymerization.

The one or more conjugated diene and/or vinyl monomers can be incorporated into the backbone of the thiocarbonate compound before it is reacted with a polyol as set forth in U.S. Pat. No. 6,596,899 granted Jul. 22, 2003, or in U.S. patent application Ser. No. 10/278,335 filed Oct. 23, 2002, or in U.S. patent application Ser. No. 10/681,679 filed Oct. 8, 2003 which are hereby fully incorporated by reference.

Alternatively, and in a similar manner, the various one or more conjugated diene monomers and/or the one or more vinyl monomers are incorporated into the backbone of the thiocarbonate compound after it has been reacted with the polyol to form a polyol-thiocarbonate block copolymer and the same patents as set forth in the preceding paragraph are hereby fully incorporated by reference.

When the conjugated diene and/or vinyl monomers are incorporated into the one or more trithiocarbonates or dithiocarbonates of formulae A, B, C, or E, the resulting trithiocarbonates and dithiocarbonates as represented by formulas block formula AA, for block formula AA′, or block formula BB, or block formula BB′, or block formula CC (mon), or block formula CC′ (mono) or block formula CC(di), or block formula CC′(di), or block formula EE(mono), or block formula EE′(di), or block formula EE(di), or block formula EE′(di) as follows:

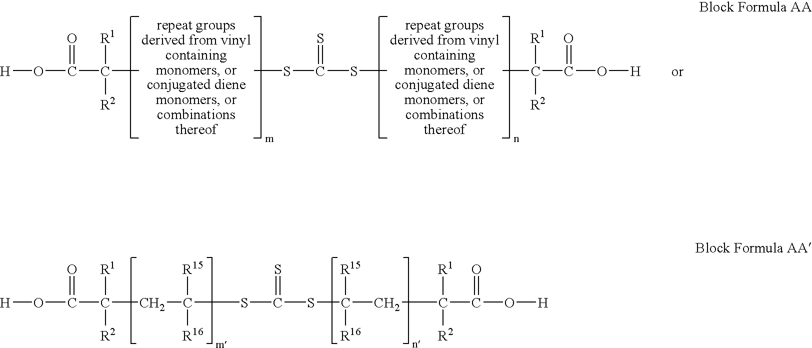

wherein R¹, R², R¹⁵, and R¹⁶ are defined hereinabove, and m, m′, n and n′, independently, is generally from about 1 to about 10,000, desirably from about 2 to about 500, and preferably from about 5 to about 100, or

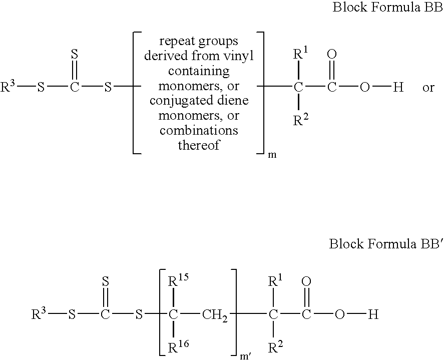

wherein R¹, R², R³, R¹⁵, and R¹⁶ are defined hereinabove, and m and m′, independently, is generally from about 1 to about 10,000, desirably from about 2 to about 500, and preferably from about 5 to about 100, or

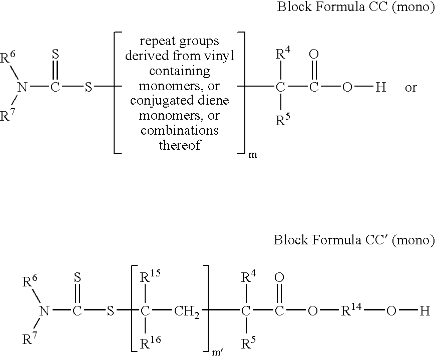

wherein R⁴, R⁵, R⁶, R⁷, R¹⁵, R¹⁶, are defined hereinabove, and m and m′ is generally from about 1 to about 10,000, desirably from about 2 to about 500, and preferably from about 5 to about 100, or

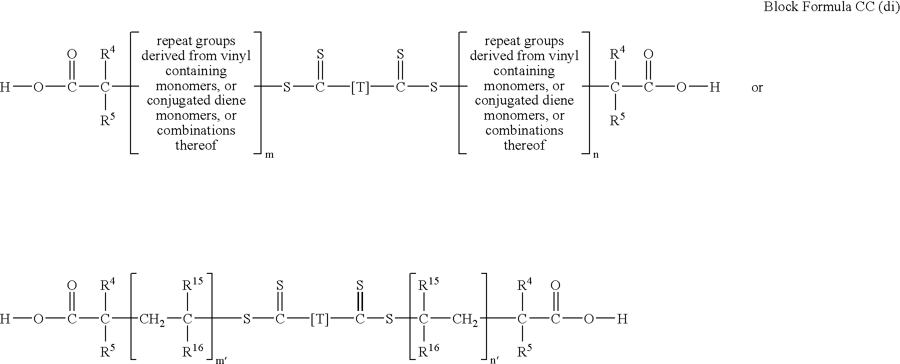

### Block Formula CC′ (di) wherein R⁴, R⁵, R¹⁵, R¹⁶, and T, are defined hereinabove, and wherein m, m′, n, and n′, independently, are generally from about 1 to about 10,000, desirably from about 2 to about 500, and preferably from about 5 to about 100, or

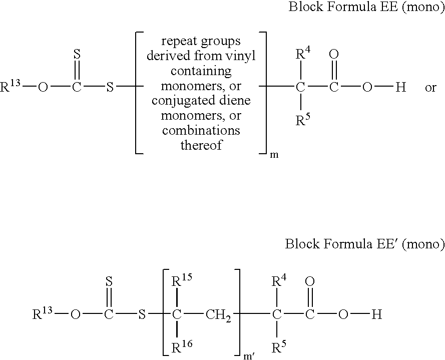

wherein R⁴, R⁵, R¹³, R¹⁵, and R¹⁶, are defined hereinabove, wherein m and m′ is generally from about 1 to about 10,000, desirably from about 2 to about 500, and preferably from about 5 to about 100, or

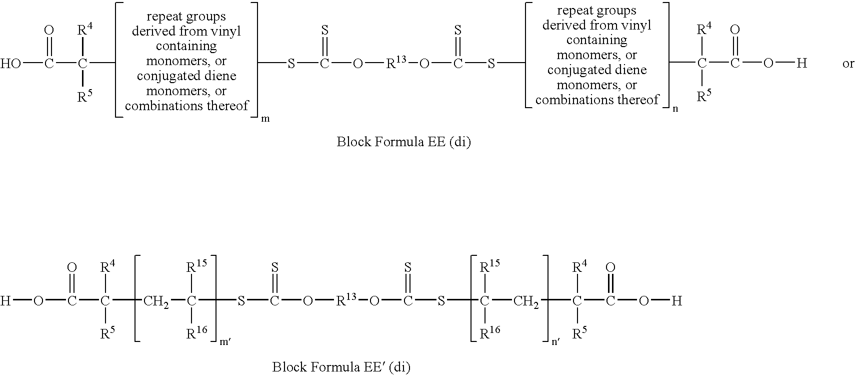

wherein R⁴, R⁵, R¹³, R¹⁵, and R¹⁶, are defined hereinabove, and wherein m, m′, n, and n′, independently, is from about 1 to about 10,000, desirably from about 2 to about 500, and preferably from about 5 to about 100.

Reactions of other thiocarbonates with various conjugated diene and/or vinyl monomers react in a similar manner, and reaction mechanisms are set forth in more detail in U.S. Pat. No. 6,596,899 issued Jul. 22, 2003; patent application Ser. Nos. 10/219,403 filed Aug. 15, 2002; 10/278,335 filed Oct. 23, 2002; and 10/681,679 filed Oct. 8, 2003 which are hereby fully incorporated by reference.

Inasmuch as one or more vinyl monomers and/or one or more diene monomers can be utilized, it is to be understood that repeat groups of the hydroxyl terminated thiocarbonate polymers or copolymers of the present invention can be the same or different. That is, random copolymers, terpolymers, etc., can be formed within the one or more m, m′, n, or n′ blocks as noted, and block copolymers can be formed by initially adding one monomer and then subsequently adding one or more different monomers (e.g. an internal block copolymer).

Other polysiloxane polyols suitable for use in the invention include block copolymers of polysiloxanes with polyethers or polyesters or polyurethanes such as polyether-b-polysiloxane-b-polyether, polysiloxane-b-polyether, or polyester-b-polysiloxane-b-polyester, polysiloxane-b-polyester, or polysiloxane-b-polyurethane-b-polysiloxane, or combinations thereof.

Considering the polysiloxane-polyether blocks, the ether repeat units can generally be derived from alkylene oxide monomers having from 2 to about 5 carbon atoms with ethylene oxide and/or propylene oxide being preferred. The preparation of polyethers is well known to the art and to the literature and the same can be readily reacted with a polysiloxane as by reacting a hydroxyl-terminated polysiloxane with alkylene oxide. The number of repeat units within each polyether block can vary widely such as from about 1 to about 200 repeat units and desirably from about 1 to about 20 repeat units with the number of repeat units in other or additional ether blocks being independently different.

The hydroxyl-terminated polysiloxane-polyester block copolymers can be formed in many ways such as by reacting a hydroxyl-terminated polysiloxane in excess with a diacid, a diester or monoacid or monoester. It can also be formed from reacting a hydroxyl-terminated polysiloxane with a carboxyl-terminated polyester, or it can be formed by reacting a hydroxyl-terminated polysiloxane with caprolactone. Polyesters are commonly made by a condensation polymerization reaction of a polycarboxylic acid or its anhydride with a polyhydric alcohol, usually with heat in the presence and a catalyst. Preferred polycarboxylic acids are dicarboxylic acids and their anhydrides. Fatty monobasic oils or fatty acids, mono-hydroxy alcohols and anhydrides may be present. Examples of acids include adipic acid, azelaic acid, sebacic acid, terephthalic acid, phthalic anhydride, and so forth. Generally the aliphatic carboxylic acids have from about 2 to about 10 carbon atoms. Other carboxylic acids such as carbonic acid or phosgene may be used in lieu of carboxylic acids under appropriate conditions. The aromatic carboxylic acids generally have from about 10 to about 30 carbon atoms. The polyhydric alcohols (polyols) generally have from about 2 to about 20 carbon atoms and from about 2 to about 5 hydroxyl groups. Polymeric polyols such as formed from the polymerization of cyclic alkylene oxides may be used as a portion or all of the polyhydric alcohol. Examples of some polyhydric alcohols include ethylene glycol, propylene glycol, diethylene glycol, dipropylene glycol, glycerine, butylene glycol, 2,2-dimethyl-1,3-propanediol, trimethylol propane, 1,4-cyclohexanedimethanol, pentaerythritol, trimethylolethane and the like. Polymeric polyols generally have number average molecular weights from about 60 to about 5,000 or about 10,000. Combinations of the polyols and the polycarboxylic acids can also be used.

The polysiloxane block can be a homogeneous block wherein only the same type of repeat unit exists throughout the polymer, or it can be a mixed block wherein two or more different types of repeat units exist within the block. For example, in Formula I, R¹ can be hydrogen and R² can be methyl, or R¹ and R² can be methyl in one repeat unit and in another repeat unit R¹ and R² can be ethyl, etc. Accordingly, it should be apparent that a great number of polysiloxane permutation can exist.

Polyhydroxyl-terminated alkylsiloxanes such as penta(hydroxypropyl)pentamethylcyclopentasiloxane, [D₅(C₃OH)] described in Polymeric Materials Science & Engineering 2003, 89, 71, or similarly tetra(hydroxypropyl)tetramethylcyclotetrasiloxane, [(D₄(C₃OH)]. In one aspect of the invention, the hydroxyl-terminated PDMS structures are telechelic structures such as DMS-C21 and DMS-C26, GE Y-14209, and DC-5562 available from Geleste.

Before the various polysiloxanes can be reacted with the thiocarbonate compound or polymers, they must contain a hydroxyl end group. The addition of such groups is well known to the art and to the literature and can be carried out by hydrosilation of silane-terminated polysiloxanes utilizing Group 9 or Group 10 catalysts of the periodic table such as palladium, platinum, or rhodium. For example, various vinyl ether alcohols can be utilized to react with the hydrogen end group of a polysiloxane such as hydroxyalkyl allyl ether, hydroxyalkyl vinylether, trimethylolpropane allyl ether, 4-vinylcyclohexane oxide, diallyl ether monoepoxide containing a total of from about 4 to about 200 carbon atoms in the presence of a catalyst and reacted generally at a temperature of from about 20 to about 100° C.

The hydroxyl-terminated polysiloxanes can be either reacted with the above noted thiocarbonate compounds, or they can be chain extended with either a polyisocyanate compound to impart elastic properties such as flexibility, or chain extended with a polycarboxylic acid compound to impart mechanical properties.

Considering chain extension utilizing a polyisocyanate compound, conventional or typical polyisocyanates can be utilized having a total of from about 4 to about 10, or about 15, or about 20 carbon atoms, including mixtures thereof. Various polyisocyanates can be generally classified as aliphatic, cycloaliphatic, or aromatic which include aliphatic groups thereon. Diisocyanates are useful to chain extend as opposed to monoisocyanates which do not chain extend and triisocyanates which will result in crosslinking.

Suitable aliphatic polyisocyanates include alpha, omega-alkylene diisocyanates having from 5 to about 20 carbon atoms, such as tetramethylene diisocyanate, hexamethylene-1,6-diisocyanate (HDI), decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include hexamethylene-1,6-diisocyanate, 2,2,4-trimethyl-hexamethylene-diisocyanate, and 2,4,4-trimethyl-hexamethylene diisocyanate.

Specific examples of suitable cycloaliphatic polyisocyanates contain from about 6 to about 20 carbon atoms and include cyclobutane-1,3-diisocyanate, 1,2-, 1,3- and 1,4-cyclohexane diisocyanates, 2,4- and 2,6-methylcyclohexane diisocyanate, 4,4′- and 2,4′-dicyclohexyldiisocyanates, 1,3,5-cyclohexane triisocyanates, isocyanatomethylcyclohexane isocyanates, isocyanatomethylcyclohexane isocyanates, bis(isocyanatomethyl)-cyclohexane diisocyanates, 4,4′- and 2,4′-bis(isocyanatomethyl)dicyclohexane, isophorone diisocyanate, and the like including derivatives, dimers, and trimers thereof. Preferred cycloaliphatic polyisocyanates include dicyclohexylmethane diisocyanate and isophorone diisocyanate.

Examples of suitable aromatic polyisocyanates contain from about 8 to about 20 carbon atoms and include 2,4- and 2,6-hexahydrotoluenediisocyanate, 1,2, 1,3, and 1,4-phenylene diisocyanates, triphenyl methane-4,4′,4″-triisocyanate, naphthylene-1,5-diisocyanate, 2,4- and 2,6-toluene diisocyanate (TDI), 2,4′-, 4,4′- and 2,2-biphenyl diisocyanates, 2,2′-, 2,4′- and 4,4′-diphenylmethane diisocyanates (MDI), Aromatic aliphatic isocyanates can also be used such as 1,2-, 1,3- and 1,4-xylylene diisocyanates and m-tetramethylxylylene diisocyanate (TMXDI), polyphenyl polymethylene polyisocyanates (PMDI), mixtures of MDI and PMDI, mixtures of PMDI and TDI, and modified polyisocyanates derived from the above isocyanates and polyisocyanates, including dimers and trimers thereof, or combinations thereof.

Another class of suitable isocyanates include the trialkoxysilylalkyl isocyanates such as trimethoxy-silylpropyl and triethoxysilylpropyl isocyanate. Examples of diisocyanates include hexamethylenes diisocyanates, MDI, and trimethylol propane diisocyanate.

A slight mole equivalent excess of the hydroxyl-terminated polysiloxane compounds or polymers are preferred so that the chain extended compound contains hydroxyl terminated polysiloxane end groups. Generally any conventional thermoplastic polyurethane catalyst known to the literature and to the art can be utilized in chain extending the polyisocyanate of the present invention. Such catalysts include organic and inorganic acid salts of, and organometallic derivatives of, bismuth, tin, iron, antimony, cobalt, thorium, aluminum, zinc, nickel, cerium, molybdenum, vanadium, copper, manganese and zirconium, as well as phosphines, tertiary organic amines, and multi-functional polyalcohol amine catalysts. Representative organotin catalysts have from about 6 to about 20 carbon atoms and include stannous octoate, dibutyltin dioctoate, dibutyltin dilaurate, and the like. Representative tertiary organic amine catalysts include triethylamine, triethylenediamine, N,N,N′N′-tetramethylethylenediamine, N,N,N′N′-tetramethylethylenediamine, N-methyl-morpholine, N-ethylmorpholine, N,N,N′,N′-tetramethylguanidine, N,N,N′,N′-tetramethyl-1,3-butanediamine, N,N-dimethylethanolamine, N,N-diethylethanolamine, diazabicyclo[2.2.2]octane, and the like. Representative polyalcohol amine catalysts include triethanolamine, diethanolamine, or bis(2-hydroxyethyl)amino-2-propanol, and the like. Chain extension of the polysiloxanes with diisocyanates are generally carried out at temperatures of from about 600 to about 220° C. and desirably from about 75° to about 200° C.

In lieu of chain extension via reaction with a diisocyanate, the polysiloxanes or polyols can be extended through an esterification reaction with various polycarboxylic acids and preferably dicarboxylic acids or anhydrides thereof having a total of from about 1 to about 20 carbon atoms. Specific examples include maleic acid, maleic anhydride, fumaric acid, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, isomers of phthalic acid, phthalic anhydride, dimeric fatty acids such as oleic acid, and the like, and mixtures thereof.

The hydroxyl- or epoxy-terminated polysiloxanes or polyols, whether or not chain extended, are reacted with at least one of the above noted thiocarbonate compounds to form an adduct. An esterification reaction is utilized with the reaction taking place either in bulk, i.e. without solvents, or in a solvent. Desired solvents include various organic compounds such as alkanes or cycloalkanes having from about 5 to about 18 carbon atoms such as hexane, heptane, or cyclohexane. Other suitable organic solvents include the various aromatic compounds generally having from 6 to about 18 carbon atoms such as benzene, toluene, chlorobenzene, and the like. Esters such as ethyl acetate, propyl acetate, butyl acetate, pentyl acetate and the like. Various alcohols and ketones can also be utilized such as ethanol, t-butyl alcohol, acetone, methyl ethyl ketone, and the like. Another suitable solvent is dimethylformamide. The esterification reaction is conducted at temperatures of from about 50° C. or about 60° C. to about 220° C. and desirably from about 70° C. to about 120° C. The use of a catalyst is optional and desired catalysts include toluene sulfonic acid, dodecanesulfonic acid, tetra-isopropyl titanate, tin tetrachloride and the like. Water is advantageously removed during the course of the esterification via distillation or azeotropically distillation with the solvent. Upon completion of the reaction, it is often desirable to remove the catalyst by filtration, washing or decantation solvents if utilized can be removed by distillation methods well known to the art.

The block copolymers of the polysiloxane or polyol, whether chain extended or not, and thiocarbonates, whether containing vinyl repeat units therein or not, can generally be represented by the formula A-B-A, B-A-B, A-B or -(A-B)ₓ— wherein A is the polysiloxane block (or polyol block) and B is the thiocarbonate-containing block or thiocarbonate vinyl polymer block. As described before, the A (polysiloxane or polyol) block can be extended with a polyurethane or a polyester block. A-B-A block copolymer is formed from a mono-hydroxyl terminated polysiloxane and/or a mono-hydroxyl terminated polyol and a di-carboxyl terminated thiocarbonate compound. The B-A-B block copolymer is formed from a di-hydroxyl polysiloxane and/or di-hydroxyl terminated polyol and a mono-carboxyl terminated thiocarbonate. The A-B block copolymer is formed from a mono-hydroxyl polysiloxane and/or a mono-hydroxyl polyol and mono-carboxyl thiocarbonate. The -(A-B)ₓ— block copolymer is formed from a di-hydroxyl polysiloxane and/or di-hydroxyl terminated polyol with a di-carboxyl thiocarbonate, wherein x represents the number of (A-B) repeat units in the polymer backbone. In one aspect of the invention x represents an integer from about 2 to about 10,000, x represents an integer from about 10 to 5000 in another aspect, and from about 15 to about 1000 is still another aspect.

If the thiocarbonate compound does not contain any vinyl repeat groups therein prior to its reaction with one or more polysiloxanes and/or polyols, the various vinyl repeat units can be polymerized into the thiocarbonate backbone after formation of the polysiloxane and/or polyol thiocarbonate adduct. This latter route is highly preferred because the esterification will be easier to perform on small rather than macro-molecules. The various vinyl monomers which can be utilized as well as the free radical initiators which can be utilized are set forth hereinabove and hence will not be repeated but rather are fully incorporated by reference. If a bulk reaction is utilized, the conjugated diene and/or vinyl monomer can be utilized as a diluent during the polysiloxane-thiocarbonate reaction. In the bulk polymerization the conjugated diene and/or vinyl monomer(s) can also serve as a diluent.

Regardless of whether incorporation of the vinyl repeat units into the thiocarbonate compound is conducted initially or preferably after the formation of the adduct, the reaction conditions are generally the same. For example, the polymerization of the vinyl monomers is generally from about room temperature to about 200° C. While the reaction can be run at temperatures lower than room temperature, but it is impractical to do so. The temperature often depends on the initiator chosen for the reaction, for example, when AIBN is utilized, the temperature generally is from about 40° C. to about 80° C., when 4,4′-azobis(4-cyanovaleric) acid is utilized, the temperature generally is from about 50° C. to about 90° C., when di-t-butylperoxide is utilized, the temperature generally is from about 110° C. to about 160° C., and when a thiocarbonate is utilized, the temperature is generally from about 80° C. to about 200° C. Azo initiators are generally preferred. If the vinyl repeat units contain an acid group therein, it is optional that the same are neutralized as with amines which are known to the art and to the literature such as dimethylaminoethyl (meth)acrylate. If the vinyl repeat units contain an amine therein, optionally they are neutralized with an acid such as hydrochloric acid or citric acid. Moreover, the number of repeat units within each thiocarbonate block is generally the same as set forth hereinabove, that is m and n, independently, is from about 1 to about 10,000, desirably from 2 to about 500, and preferably from about 5 to about 100 repeat units.

The end result is the formation of a block copolymer having at least one polysiloxane block and at least one thiocarbonate block having vinyl repeat units therein and is set forth in block formulas AA or AA′ or block formulas BB or BB′, or block formulas CC (mono) or CC′ (mono), or block formulas CC (di) or CC′ (di), or EE (mono) or EE′ (mono), or EE (di) or EE′ (di). However, when a thiocarbonate compound is formed according to any of the block formulas EE or EE′, either a (mono) or (di), utilization of methacrylate monomers results in the formation of homopolymers of polymethacrylate which are not incorporated into the thiocarbonate compound. In order to prevent this, a small amount of an acrylate comonomer is utilized, for example at least 2% by weight, so that the monomers are generally incorporated into a thiocarbonate compound.

Should crosslinked block copolymers be desired, they can be formed in a number of different ways. For example, if the polysiloxane or polyol is chain extended with an isocyanate, it can be crosslinked with a triisocyanate. Similarly, if the polysiloxane or polyol is chain extended with a carboxylic acid, it can be crosslinked with a tricarboxylic acid. Such compounds are known to the art as well as to the literature. Crosslinking can be introduced during or before the vinyl polymerization if needed. For example, crosslinkable monomers such as diacetone acrylamide, 2-methacryloyloxy)ethyl acetoacetate, 3-(trimethoxysilyl)propyl acrylate, di- or tri(meth)acrylates, diacrylamide and the like can be incorporated in the vinyl polymer backbone. Examples of prepolymerization crosslinking agents include co-esterification of the hydroxyl-terminated silicone polymers or polyols with di- and tri-allyl pentaerythritol, allyl sucrose and the like, followed by vinyl polymerization.

While in accordance with the patent statutes, the best mode and preferred embodiment have been set forth, the scope of the invention is not limited thereto, but rather by the scope of the attached claims.

In the following examples, the first order kinetics, In (M₀/M) where M₀ is the initial monomer concentration and M is monomer concentration at a given time was plotted against time. The near straight line indicated that all the polymerization are well-controlled.

### EXAMPLE 1

16 g ester is made from a carboxyl-terminated RAFT agent and bis-hydroxyalkyl-terminated polydimethylsiloxane. 335.4 g N,N-dimethyl-S-isobutyric acid dithiocarbamate (DMDTC), 1822.5 g GE Silsoft 802 (Mw˜2500) and 18 g p-toluenesulfonic acid are mixed with 1.5 liter of cyclohexane and refluxed for 8 hours. A Dean-Stark trap is used to collect water that is formed. The reaction is let to cool down to room temperature. The organic solution is decanted and concentrated to a yellow oil. HNMR confirms the formation of the ester in very pure form. In the polymerization, 70 g of the ester, 140 g 2-dimethylaminoethyl methacrylate (DMAEMA), 70 g N,N′-dimethylacrylamide (DMA), 1.75 g 2,2′-bis-(2-methylbutyronitrile) (Vazo-67) and 420 g ethyl acetate were mixed and bubbled with nitrogen gas for 20 minutes. The reaction is then heated at 75° C. for 5 hours. 0.7 g Vazo 67 is added and heating continues for 3 more hours. Solvent is removed and the block copolymer is collected as a yellow solid. Conversion from gas chromatography analysis: DMAEMA, 98%; DMA, 92%. Molecular weights from GPC: Mn, 8.5K; Mw, 27K. A 5% of the polymer makes a clear ethanol/water (55/45) solution. In a similar polymerization, 70 g of the ester made from DMS-C21 (a dihydroxyl-terminated PDMS from Gelest, Inc. Mw˜5,000) and DMDTC, 140 g DMAEMA, 70 g DMA, 1.5 g Vazo-67 and 420 g ethyl acetate were reacted the same way as before for 6.5 hours at 75° C. 0.8 g more of Vazo-67 was added and reacted for 5 more hours. The resulting polymer has a Mn of 13348 and Mw of 44039.

### EXAMPLE 2

16 g ester made from Silsoft 802 and DMDTC, 34 g DMAEMA, 14 g t-butyl acrylate (t-BA), 0.4 g Vazo-67 and 21.7 g anhydrous ethanol were mixed and purged with nitrogen before heating to 70° C. for 1.5 hours before adding 0.4 g Vazo-67 in 2 g ethanol. The temperature was raised to 75° C. for 3 hours before adding 0.4 g Vazo-67 in 2 g ethanol and the reaction was kept at 80° C. for 5 more hours. Cooled down to 25 to 30° C. before a solution of 5.25 g citric acid in 80.65 g water was added to keep the temperature below 40° C. The final product is a off-white dispersion.

### EXAMPLE 3

16 g ester made from Silsoft 802 and DMDTC, 34 g DMAEMA, 14 g t-BA, 4 g acrylic acid (AA), 0.4 g Vazo-67 and 23.1 g anhydrous ethanol were mixed and purged with nitrogen before heating to 70° C. for 2 hours 50 minutes before adding 0.4 g Vazo-67 in 2 g ethanol. The reaction was heated at 75° C. for 3 more hours before adding 0.4 g Vazo-67 in 2 g ethanol and heated to 80° C. for 5 more hours. Cooled down to room temperature and added 77.46 g water while stirring to give a yellow-colored dispersion.

### EXAMPLE 4

10 g of the ester made from Silsoft 802 and S-dodecyl-S′-isobutyric acid trithiocarbonate (DTTC), 20 g DMAEMA, 0.1 g Vazo-67 and 30 g ethanol were mixed and purged with nitrogen before heating to 65° C. for 5 hours before adding 0.05 g of Vazo-67 and heating at 80° C. for 5.5 hours. A very thick yellow paste was obtained. Mn: 15630, Mw: 58950.

### EXAMPLE 5

Silsoft 802 was chain-extended with 2,2,4-trimethyl-1,6-haxanediisocyante to give dihydroxyl-terminated polyurethane of Mn 8346 as determined by hydroxyl numbers measurement. 10 g of ester made from the polyurethanediol and DMDTC, 10 g N-vinylpyrrolidone (VP), 10 g dimethylaminoethyl acrylate (DMAEA), and 30 g ethanol were polymerized similarly as in Example 4 with Vazo-67 to give a yellow liquid. Mn: 11108, Mw: 26428.

### EXAMPLE 6

5 g of the ester made from DMS-C21 and DMDTC, 10 g butyl acrylate (BA) and 15 g ethanol and polymerized in the presence of Vazo-67 in a similar manner as in Example 4 to give a clear polymer. Mn: 6420, Mw: 17118.

### EXAMPLE 7

4 g of the ester made from Y-14830, an developmental telechelic dihydroxyalkyl-terminated PDMS from GE with Mn˜8,400, and DMDTC, 8 g methyl methacrylate (MMA), 4 g t-BA and 16 g 2-butanone were polymerized with Vazo-67 in a similar manner as in Example 4 to give white elastomeric polymer.

### EXAMPLE 8

4 g of the ester made from Silwet L-7604, a monohydroxyl-terminated PDMS from GE, and DMDTC, 8 g of DMAEMA, 4 g DMA and 16 g ethyl acetate were polymerized with Vazo-67 as in Example 4 to give a viscous polymer with Mn: 4697 and Mw: 22592.

### EXAMPLE 9

0.3 g of the ester made from DMS-C21 from Gelest and DMDTC, 50 g acrylic acid, 0.2 g triallylpentaerythritol, 131.8 g ethyl acetate, 112.2 g cyclohexane were polymerized with 0.1 g Trigonox THP as catalyst at 45° C. for 8 hours. The solvent was evaporated to obtain white powders after drying in the 50° C. oven for 5 hours. 1% of a neutralized aqueous solution gave a very viscous and smooth gel.

### EXAMPLE 10

0.7 g of the same ester made from polyurethanediol and DMDTC as described in Example 5, 47.5 g acrylic acid, 2.5 g of stearyl methacrylate (SMA) 0.15 g triallyl pentaerythritol and a mixed solvent of 131.8 g ethyl acetate and 112.2 g cyclohexane were polymerized with two charges of Trigonox EHP (0.1 g and 0.05 g) as initiator at 45° C. for 8 hours. White solid started to precipitate in the first hour. The product was isolated as white powders by evaporation of the solvent and oven-drying. 1% of aqueous solution neutralized to PH 7 gave a smooth and shiny gel.

### EXAMPLE 11

DMDTC (12.42 g, 0.06 mole), poly THF (OH# 55.1, 41.21 g, 0.03 mole), p-toluene sulfonic acid (0.6 g, 3 mmole) and 74 g toluene were refluxed with a Dean-Stark trap. 1.1 g water was collected after 3.5 hours. The solution was used directly in the synthesis of the A-B-A block copolymer. An aliquot of the solution was concentrated to give the ester. ¹HNMR (CDCl₃): 1.61 (s, 108H), 1.71 (s, 12H), 3.33 and 3.41 (2s, 12H), 3.42 (s, 104H), 4.14 (t, 4H). IR (cm⁻¹): 1732. Mn from GPC: 3100, DPI: 2.11. 20 g of the crude toluene solution, 20 g butyl acrylate, 10 g methyl methacrylate, 0.05 g Vazo® 67, and 30 g additional toluene were polymerized under nitrogen in a process as described before for 6 hours. Mn of the block copolymer: 10,000, PDI: 2.04

### EXAMPLE 12

DMDTC (20.7 g, 0.1 mole), polypropylene glycol(PPG-3025 from Bayer, OH# 35.74) (157 g, 0.05 mole), toluenesulfonic acid (1.0 g, 5 mmole) and 180 g toluene were refluxed under nitrogen with a Dean-Stark trap. 1.8 g water was collected in 3 hours. The solution was used directly in the synthesis of the block copolymer. An aliquot of the solution was concentrated to give the macro-ester as yellow oil. HNMR (CDCl₃): 1.1-1.3 (m, 161H), 1.72-1.74 (m, 12H)), 3.3-3.8 (m, 173H), 4.1 (m, 0.2H) and 5.0 (m, 1.9H). IR (cm−1): 1730. GPC showed Mn: 3030 and DPI: 1.5. 20 g of the crude toluene solution, 15 g ethyl acrylate, 10 g methyl methacrylate were mixed with 25 g additional toluene. 0.08 g Vazo-67 was added and the solution was purged with nitrogen for 15 minutes. The temperature was raised to 80° C. and stirred for 5 hours. GPC of the concentrated colorless oil showed a Mn of 11,800 and DPI of 2.05.

### EXAMPLE 13

15 g of the macro-ester prepared in Example 12, 25 g ethyl acrylate, 14 g methyl methacrylate, 21 g acrylic acid, 0.3 g V-601® initiator (Wakko Chime), and 38 g cyclohexane were heated to 80° C. for 5 hours before adding 0.3 g V-601® in 1 g cyclohexane. Heating continued for 5 hours before adding another 0.2 g V-601® in 1 g cyclohexane. The polymerization temperature was raised to 100° C. for 2 hours then cooled down to 80° C. 20 mm Hg vacuum was applied and the solvent was distilled off. Cooled down and vacuum was released. 120 g water, 20 g 2-amino-2-methyl-1-propanol and 20 g ethanol were added. Heated to 80° C. under 20 mm Hg vacuum to distill off azeotrope of cyclohexane-water-ethanol to obtain a white dispersion, which dissolved in water upon further dilution. GC analysis showed that the dispersion contained 5.5% ethanol, less than 20 ppm of methyl methacrylate and less than 0.5 ppm of ethyl acrylate.

### EXAMPLE 14

DMDTC (22 g, 0.106 mole), polyethylene glycol monomethylether (75 g, ˜0.1 mole), toluenesulfonic acid (1 g, 0.6 mmole) were refluxed with 100 ml toluene under nitrogen with a Daen-Stark trap. 1.8 ml water was collected in 6 hours. The solution was cooled down, washed with 20 ml saturated sodium carbonate solution and dried over magnesium sulfate before concentrating to a clear oil. 2.5 g of the oil, 15 g ethyl acetate, 10 g methyl methacrylate, 0.01 g Vazo® 67 initiator, and 27.5 g methyl ethyl ketone were heated under nitrogen for 4 hours, added 0.1 g Vazo® 67 and heated for 5 more hours to get colorless polymer, Mn: 17,000

### EXAMPLE 15

α,ω-dihydroxy-terminated PDMS (Dow Corning 5562 fluid, OH#: 41.25) (172 g, 0.115 mole), DMDTC (48.42 g, 0.234 mole), p-toluenesulfonic acid monohydrate (3.36 g, 0.018 mole) were refluxed with 131 g cyclohexane under nitrogen. Water was formed and removed with the help of Dean-Stark trap in 8 hours. The solution was cooled down and decanted to another flask for concentration to afford clear yellow oil.

17.75 g of the oil, 168.62 g butyl acrylate, 79.87 g methyl methacrylate, 17.75 g acrylonitrile, 17.75 g methacrylic acid, 0.28 g Vazo® 67, and 80 g Texanol were heated to 80° C. under nitrogen for 5 hours. 0.28 g Vazo® 67 in 80 g Texanol was added and heating continued for 2 more hours. 0.28 g Vazo® 67 in 1 g Texanol was added and heated for 45 minutes at 95 to 100° C. before cooling down. GPC of the thick oil showed a Mn of 33,000 and Mw of 71,000. Place 188 g of the polymer in a beaker and stirred with 181 g water before adding 10 g triethylamine to afford a white milky dispersion.

What is claimed is:

1. A block copolymer formed from the esterification reaction of a carboxyl terminated thiocarbonate compound and a compound containing at least one hydroxyl group.

2. A block copolymer of claim 1 wherein said copolymer is an A-B-A block copolymer and said A block is a residue of a monoalcohol and said B block is a residue of thiocarbonate compound having two carboxylic acid groups.

3. A block copolymer of claim 1 wherein said copolymer is a B-A-B block copolymer and said A block is a residue of a compound having two hydroxyl groups, and said B block is a residue of a monocarboxylic thiocarbonate compound.

4. A block copolymer of claim 1 wherein said copolymer is a -(A-B)ₓ— -block copolymer and said A block is a residue of a compound having two hydroxyl groups, and said B block is a residue of a thiocarbonate compound having two carboxylic acid groups.

5. A block copolymer of claim 1 wherein said thiocarbonate compound contains repeat units polymerized from a monomer selected from a conjugated diene, a vinyl monomer, and mixtures thereof.

6. A block copolymer of claim 1 wherein said thiocarbonate compound is selected from one or more compounds represented the formulae: 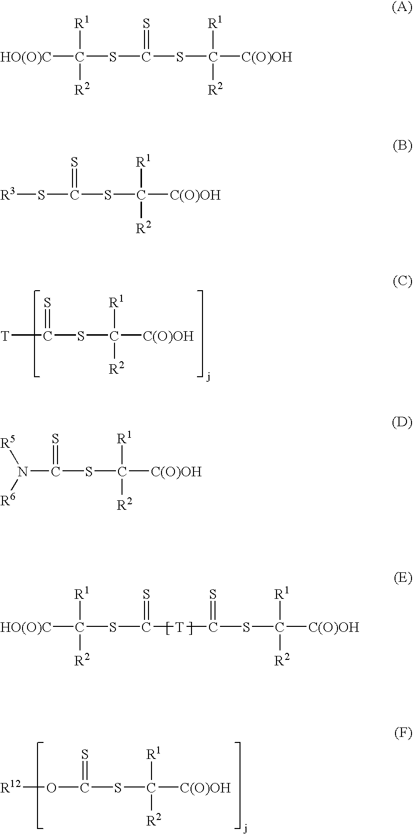
wherein R¹ and R², independently represent linear and branched, substituted and unsubstituted C₁ to C₆ alkyl; substituted and unsubstituted C₆ to C₂₄ aryl, optionally containing heteroatoms selected from nitrogen, oxygen, sulfur, and phosphorous; R¹ and R² taken together with the carbon atom to which they are attached form a cyclic ring having from 3 to about 12 total carbon atoms; when R¹ and R² are substituted, the substituents are independently selected from linear and branched C₁ to C₆ alkyl, C₁ to C₂₀ alkoxy, C₆ to C₁₄ aryl, halogen, and combinations thereof; R³ is selected from substituted and unsubstituted benzyl; linear and branched, substituted and unsubstituted C₁ to C₁₈ alkyl; when R³ is substituted, the substituents are independently selected from C₁ to C₅ alkyl; C₁ to C₂₀ alkoxy; C₁ to C₁₈ hydroxyalkyl; C₆ to C₁₈ aryl; C₇ to C₂₄ aralkyl; C₁ to C₁₀ cyanoalkyl; C₁ to C₁₀ aminoalkyl; mono-(C₁ to C₄) alkylamino (C₁ to C₈) alkyl; di-(C₁ to C₄) alkylamino (C₁ to C₈) alkyl; C₁ to C₂₄ carboxylalkyl; C₁ to C₁₀ mercaptoalkyl; carboalkoxyalkyl (alkoxycarbonylalkyl), wherein said alkoxy moiety contains 1 to 10 carbon atoms and said alkyl moiety contains 1 to 20 carbon atoms, halogen, hydroxyl, and combinations thereof; wherein R⁵ and R⁶ independently represent hydrogen; linear and branched, substituted and unsubstituted C₁ to C₁₈ alkyl; substituted and unsubstituted C₆ to C₂₄ aryl, optionally containing heteroatoms, selected from nitrogen, oxygen, sulfur, and phosphorous; substituted or unsubstituted C₇ to C₁₈ arylalkyl; substituted or unsubstituted C₂ to C₁₈ alkenyl; a residue of a polyalkylene glycol ether having from 4 to 200 carbon atoms; when R⁵ and R⁶ are substituted, the substituents are independently selected from linear and branched C₁ to C₆ alkyl, C₁ to C₂₀ alkoxy, C₆ to C₁₄ aryl, halogen, cyano, nitro, and combinations thereof; R⁵ and R⁶ taken together with the nitrogen atom to which they are attached can form a substituted and unsubstituted monocyclic and multicyclic ring system containing 4 to 12 carbon atoms, optionally containing heteroatoms selected from nitrogen, oxygen, sulfur, phosphorous, and combinations thereof; R¹² is selected from a linear and branched, substituted and unsubstituted C₁ to C₁₂ alkyl; linear and branched, substituted and unsubstituted C₂ to C₁₂ alkenyl; substituted and unsubstituted C₆ to C₂₄ aryl, optionally containing heteroatoms selected from nitrogen, oxygen, sulfur, phosphorous and combinations thereof; C₇ to C₁₈ arylalkyl; an acyl group; alkoxyalkyl having 1 to 20 carbon atoms; a residue of a polyalkylene glycol ether having from 4 to about 200 carbon atoms derived from a polyalkylene glycol monoaryl ether having from 3 to 200 carbon atoms; a polyfluoroalkyl group having 1 to 25 carbon atoms; a phosphorous containing C₁ to C₁₀ alkyl; when R¹² is substituted, the substituents are independently selected from C₁ to C₅ alkyl; C₂ to C₁₀ alkenyl; C₁ to C₂₀ alkoxy; C₁ to C₁₈ hydroxyalkyl; C₆ to C₁₈ aryl; C₇ to C₂₄ aralkyl; C₁ to C₁₀ cyanoalkyl; an amino group; C₁ to C₂₄ carboxylalkyl; C₁ to C₁₀ mercaptoalkyl; carboalkoxyalkyl (alkoxycarbonylalkyl), where the alkoxy moiety contains 1 to 10 carbon atoms and the alkyl moiety contains 1 to 20 carbon atoms; carboalkoxy (alkoxycarbonyl), where the alkoxy moiety contains 1 to 10 carbon atoms; alkylcarbonyl, where the alkyl moiety contains 1 to 20 carbon atoms; alkylarylcarbonyl, where the alkyl group contains 1 to 20 carbon atoms and the aryl group contains 6 to 18 carbon atoms; alkoxycarbonyl where the alkoxy moiety contains 1 to 10 carbon atoms; arylcarbonyl group, where the aryl group contains 6 to 18 carbon atoms; arylalkylcarbonyl, where the aryl group contains 6 to 18 carbon atoms and the alkyl group contains 1 to 20 carbon atoms; a heterocyclic group containing 3 to 8 carbon atoms, wherein the hetero atom is selected from oxygen, nitrogen, sulfur, and combinations thereof; an acyloxy group; a carbamoyl group; a phthalimido group; a maleimido group; a succinimido group; amidino group; guanidimo group; a quaternary ammonium salt substituent; an allyl group; epoxy group; halogen; carboxyl and alkali metal salts thereof; hydroxyl; cyano, nitro; and combinations thereof; in formula (C) j is 1 or 2, subject to the proviso that when j is 1, T is —NR⁵R⁶, wherein R⁵ and R⁶ are as previously defined, and when j is 2, T is a divalent radical having a nitrogen atom directly connected to each carbon atom of the adjacent thiocarbonyl groups represented by the formulae: 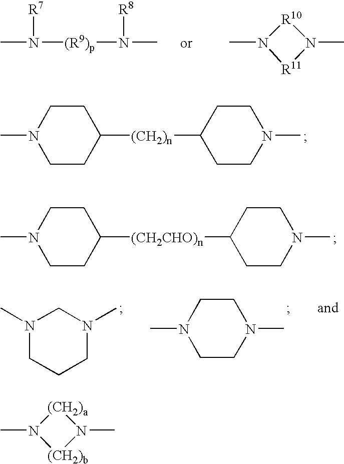
wherein p is 0 or 1; R⁷ and R⁸, independently represents hydrogen; linear and branched, substituted or unsubstituted C₁ to C₁₈ alkyl; substituted or unsubstituted C₆ to C₂₄ aryl; substituted or unsubstituted C₇ to C₁₈ arylalkyl; substituted or unsubstituted C₂ to C₁₈ alkenyl; R⁹ is a bridging moiety, selected from substituted and unsubstituted C₂ to C₁₈ alkylene, a divalent polyalkylene glycol ether residue having from 4 to about 200 carbon atoms; a carbonyl group, a heteroatom selected from nitrogen, oxygen, sulfur and phosphorous; and combinations of thereof; R¹⁰ and R¹¹ independently represent substituted or unsubstituted C₁ to C₄ alkylene group, when R⁷ to R¹¹ are substituted, the substituents are independently selected from linear and branched C₁ to C₆ alkyl, C₁ to C₂₀ alkoxy, C₆ to C₁₄ aryl, halogen, cyano, nitro, and combinations thereof; n is 0 to 18; and a and b independently represent an integer from 1 to 3.

7. A block copolymer of claim 1 wherein said compound containing at least one hydroxyl group is selected from C₈ to C₅₀ fatty alcohols; polyalkene monoalcohols; alkoxypoly(oxyalkylene) glycols; fluorinated monoalcohols;
polysiloxane monoalcohols; and mixtures thereof.

8. A block copolymer of claim 1 wherein said compound containing at least one hydroxyl group is selected from polyester polyols; polyether polyols; polycarbonate polyols; polycaprolactone polyols; polyurethane diols; fluoropolyether diols; fluorinated alkane diols; polyorganosiloxane polyols, alkoxylated polyorganosiloxane polyols; vegetable oil derived polyols; hyperbranched polyols; graft polymer polyols; polybutadiene polyols; hydrogenated polybutadiene polyols; star polyols; natural and synthetic polysaccharides, a compound represented by the formula:
HO—R¹⁸—(OH)ₙ
R¹⁸ is selected from a linear and branched, substituted and unsubstituted hydrocarbon moiety containing 2 to 200 carbon atoms, optionally containing heteroatoms and/or hetero groups selected from carbonyl, oxygen, nitrogen, sulfur, phosphorous, and combinations thereof; a substituted and unsubstituted cycloalkanediyl moiety containing 3 to 10 carbon atoms; a substituted and unsubstituted arenediyl moiety containing 6 to 24 carbon atoms, optionally containing heteroatoms selected from oxygen, nitrogen, sulfur, and combinations thereof; when the foregoing moieties are substituted, the substituents are independently selected from linear and branched C₁ to C₆ alkyl, C₁ to C₂₀ alkoxy, C₆ to C₁₄ aryl, halogen, cyano, nitro, and combinations thereof; wherein n is an integer from 1 to about 25.

9. A block copolymer of claim 5 wherein said vinyl monomer is represented by the formula: 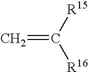
wherein R¹⁵ is selected from hydrogen, halogen, substituted and unsubstituted C₁ to C₄ alkyl, where the substituents, independently, are selected from hydroxy, alkoxy, aryloxy(OR¹⁷), carboxy, metal carboxylate (COOM) wherein M is selected from sodium, potassium, calcium, zinc, and ammonium salts, acyloxy, aroyloxy(O₂CR¹⁷), alkoxy-carbonyl(CO₂R¹⁷), or aryloxy-carbonyl, and combinations thereof; R¹⁶ is selected from hydrogen, R⁷, CO₂H, CO₂R¹⁷, COR⁷, CN, CONH₂, CONHR¹⁷, O₂CR¹⁷, OR¹⁷, and halogen; R⁷, independently, represents substituted and unsubstituted C₁ to C₁₈ alkyl, substituted and unsubstituted C₂ to C₁₈ alkenyl, substituted and unsubstituted aryl, substituted and unsubstituted aralkyl, substituted and unsubstituted alkaryl, where the substituents, independently, are selected form epoxy, hydroxy, alkoxy, acyl, acyloxy, carboxy, metal carboxylate (COOM) wherein M is selected from sodium, potassium, calcium, zinc, and ammonium salts, sulfonic acid (and salts thereof), alkoxy- or aryloxy-carbonyl, dicyanato, cyano, silyl, halo and C₁ to C₁₀ dialkylamino.
